(19) United States
(12) Patent Application Publication
(10) Pub. No.: US 2026/0118609 A1
(43) Pub. Date: Apr. 30, 2026

(54) BACK SIDE POWER DELIVERY FOR WAFER-SCALE INTEGRATION WITH LASER ASSISTED BONDING

(71) Applicant: Volantis Semiconductor, Inc., Portland, OR (US)

(72) Inventor: Tapabrata Ghosh, San Francisco, CA (US)

(73) Assignee: Volantis Semiconductor, Inc., Portland, OR (US)

(21) Appl. No.: 19/093,546

(22) Filed: Mar. 28, 2025

Related U.S. Application Data
(63) Continuation-in-part of application No. 19/079,851, filed on Mar. 14, 2025.
Application No. 19/079,851 is a continuation-in-part of application No. 19/056,456, filed on Feb. 18, 2025.
Application No. 19/056,456 is a continuation-in-part of application No. 19/023,647, filed on Jan. 16, 2025.
Application No. 19/023,647 is a continuation-in-part of application No. 18/978,188, filed on Dec. 12, 2024.
Application No. 18/978,188 is a continuation-in-part of application No. 18/958,107, filed on Nov. 25, 2024.
Application No. 18/958,107 is a continuation-in-part of application No. 18/940,944, filed on Nov. 8, 2024.
(60) Provisional application No. 63/714,353, filed on Oct. 31, 2024.
(60) Provisional application No. 63/720,216, filed on Nov. 14, 2024.
(60) Provisional application No. 63/750,817, filed on Jan. 29, 2025.
(60) Provisional application No. 63/750,822, filed on Jan. 29, 2025.

(51) Int. Cl. G02B 6/42

(52) U.S. Cl. CPC G02B 6/4274; G02B 6/4238; G02B 6/4239; G02B 6/4269; G02B 6/4286

(57) ABSTRACT

Disclosed techniques enable provide techniques for improved power delivery for wafer-scale integration. A wafer-scale integration interposer (WSII) is accessed. A front side of the WSII is bonded to a plurality of chiplets. The WSII includes through-silicon vias (TSVs). A plurality of modular power substrates (MPSs) is bonded to a back side of the WSII. The bonding is accomplished via laser-assisted bonding (LAB). The LAB comprises reflowing, by a laser, one or more solder balls. The bonding is based on the one or more solder balls that were reflowed. The reflowing comprises shining the laser through a front side of the WSII. The plurality of MPSs is coupled electrically to a plurality of DC-to-DC power converters. The plurality of DC-to-DC power converters sends DC power to the plurality of chiplets. The sending is based on the plurality of MPSs and the plurality of TSVs.

### RELATED APPLICATIONS

This application is a continuation-in-part of U.S. patent application “Photonic wafer-scale interposer with tapered waveguides”Ser. No. 19/079,851, filed Mar. 14, 2025.

The U.S. patent application “Photonic wafer-scale interposer with tapered waveguides” Ser. No. 19/079,851, filed Mar. 14, 2025 is also a continuation-in-part of U.S. patent application “Back Side Power Delivery For Wafer-Scale Integration With An Isometric Grid Compression Plate” Ser. No. 19/056,456, filed Feb. 18, 2025, which claims the benefit of U.S. provisional patent applications “Chiplet-Based Optical Wafer-Scale Network Switch” Ser. No. 63/750,817, filed Jan. 29, 2025, and “Wafer-Scale Integration Power Delivery With An Isotropic Conductive Adhesive”Ser. No. 63/750,822, filed Jan. 29, 2025.

The U.S. patent application “Back Side Power Delivery For Wafer-Scale Integration With An Isometric Grid Compression Plate” Ser. No. 19/056,456, filed Feb. 18, 2025, is also a continuation-in-part of U.S. patent application “Back Side Power Delivery For Wafer-Scale Integration With Solderless Modular Power Substrates” Ser. No. 19/023,647, filed Jan. 16, 2025, which claims the benefit of U.S. provisional patent applications “Cooling for Wafer-Scale Integration With Back Side Power Coupling” Ser. No. 63/714,353, filed Oct. 31, 2024, and “Back Side Wafer-Scale Power Delivery With An Anisotropic Conductive Film” Ser. No. 63/720,216, filed Nov. 14, 2024.

The U.S. patent application “Back Side Power Delivery For Wafer-Scale Integration With Solderless Modular Power Substrates” Ser. No. 19/023,647, filed Jan. 16, 2025 is also a continuation-in-part of U.S. patent application “Wafer-Scale Integration With A Stiffening Isometric Grid Array” Ser. No. 18/978,188, filed Dec. 12, 2024, which claims the benefit of U.S. provisional patent applications “Cooling for Wafer-Scale Integration With Back Side Power Coupling” Ser. No. 63/714,353, filed Oct. 31, 2024, and “Back Side Wafer-Scale Power Delivery With An Anisotropic Conductive Film” Ser. No. 63/720,216, filed Nov. 14, 2024.

The U.S. patent application “Wafer-Scale Integration With A Stiffening Isometric Grid Array” Ser. No. 18/978,188, filed Dec. 12, 2024 is also a continuation-in-part of U.S. patent application “Cold Plate Cooling For Wafer-Scale Integration With Back Side Modular Power Delivery” Ser. No. 18/958,107, filed Nov. 25, 2024, which claims the benefit of U.S. provisional patent applications “Cooling for Wafer-Scale Integration With Back Side Power Coupling” Ser. No. 63/714,353, filed Oct. 31, 2024, and “Back Side Wafer-Scale Power Delivery With An Anisotropic Conductive Film”Ser. No. 63/720,216, filed Nov. 14, 2024.

The U.S. patent application “Cold Plate Cooling For Wafer-Scale Integration With Back Side Modular Power Delivery” Ser. No. 18/958,107, filed Nov. 25, 2024, is also a continuation-in-part of U.S. patent application “Back Side Wafer-Scale Integration With Modular Power Delivery” Ser. No. 18/940,944, filed Nov. 8, 2024, which claims the benefit of U.S. provisional patent application “Cooling for Wafer-Scale Integration With Back Side Power Coupling”Ser. No. 63/714,353, filed Oct. 31, 2024.

Each of the foregoing applications is hereby incorporated by reference in its entirety.

### FIELD OF ART

This application relates generally to power delivery and more particularly to back side power delivery for wafer-scale integration with laser assisted bonding.

### BACKGROUND

Plans for the provisioning of electrical power to homes, schools, farms, hospitals, factories, government buildings, and other structures have created proposals based on a fundamental debate: should the electrical power be provided based on direct current (DC) or on alternating current (AC)? Each proposal has had its proponents who touted the advantages and disadvantages of each. Historically, Thomas Edison proposed a DC power system that would include a generator on every block. Edison argued that DC power was simple to generate, could be easily stored in batteries, and was safe at low voltages. DC power could be used without conversion to power incandescent bulbs, motors, and other simple devices of the day. Nicola Tesla proposed and developed AC power. In the United States, George Westinghouse built an AC power system to compete with Edison's DC power system. Although AC power had to be converted to operate some devices, AC power generation could be centralized because the AC power could be transmitted over much longer distances. Known as “The War of the Currents,” AC power generation quickly won the debate and became the standard for power generation worldwide. The generation of AC power remains the standard to this day, although different countries and regions have standardized different voltages and frequencies for the AC power.

Modern electronic systems operate on a range of voltages and on DC or AC power. Systems such as those in massive AI data centers can require massive amounts of AC power. The AC power is converted to DC power to operate servers, storage systems, and networking equipment, among other devices. At the other end of the device spectrum, handheld and body-worn devices, such as smartwatches, include batteries that provide DC power. While the amount of power required by these vastly different systems ranges over many orders of magnitude, the fact remains that the power delivered to the systems must be stable and reliable. Large “server farms” such as those for AI applications are built near power sources such as hydropower, geothermal power, and nuclear power. These large installations provide significant backup power to ensure that the system can operate reliably 24×7.

DC devices including laptop computers, handheld devices, and body-worn devices have benefited significantly from improved battery technologies. New battery technologies are more reliable and provide stable power for longer periods of time. The new batteries provide improved power density and faster charging times, among other benefits, compared to earlier battery types. “Old fashioned” nickel-cadmium (NiCd) batteries and lead-acid batteries of yesteryear have given way to better technologies and chemistries that now include nickel-metal hydride (NiMH) and lithium-ion (Li-ion). These latter batteries offer higher power densities per unit volume, plus longer lasting and more stable power delivery. Another new battery type includes lithium-iron-phosphate (LiFePO4). This latter type offers increased power output, faster charging, and lower weight compared to other cells such as sealed lead acid ones. Whatever the approach, new designs are needed to meet the increasing demand for energy.

### SUMMARY

Faster computers and other electronic devices, and better, more interesting applications, are the often heard demands of users. As users who range in skill level from basic user to corporate IT executive find more uses for their computers and devices, they demand device features and capabilities that improve the usability of the devices. Typical device features routinely now include biometric access, high resolution cameras, and three-dimensional audio. These user requirements span the wide range of computing devices and personal devices. Whether the computers are based on vast server farms, or are handheld devices such as smartphones, users always desire systems, devices, and applications that are faster, more capable, and more reliable than the systems, devices, and software currently in use. As a result, circuit designers continue to design and to fabricate ever improved integrated circuits that present greatly increased processing performance, expanded data processing options, and “product differentiating” features. The differentiating features, more than mere marketing hype, now typically include larger or folding touchscreens, higher resolution cameras with multiple lenses, spatial audio that simulates different listening environments, biometric sensing for facial and fingerprint recognition, and “fun” applications that range from games to personal emoji generators, among many other enhancements. However, increasing chip processing speeds and other capabilities such as AI processing force the addition of complex and often large circuitry into the chips. In order to add new circuitry into the chips, designers employ two main design philosophies: increase the physical dimensions of the chip by making the chip larger or increase circuit density by reducing feature sizes. These techniques have to date been successful in meeting the never-ending customer demands for increased performance. Microprocessors, graphics processors, machine learning accelerators, systems-on-chips (SoCs), and so on currently boast transistor counts into the tens of billions. Commensurate with increasing processor and software performance, the chip architectural improvements and added device features increase the power density of the chips, resulting in prodigious heat generation.

To further address the never-ending drive for performance, some engineers have turned to wafer-scale integration. Ideally, a chip would be the size of an entire wafer (which can be called a monolithic wafer), and the circuit feature sizes would include greatly reduced transistor sizes, minimum contact sizes, smaller wire widths and separation, and reductions of all other dimensions related to circuitry. In another approach to wafer-scale integration, the wafer can form an interposer with bonded or fabricated chiplets. Regardless of the methodology, to increase interconnection options, designers have considered through-silicon vias to provide direct connections between a front side of a chip or wafer and a back side of a chip or wafer. However, to reliably fabricate such interconnects, the wafers, for example, must be ground or polished to a thinness that supports the fabrication of the through-silicon vias. As a result, the thinned wafers (or chips) are prone to fracturing, not only because of the delicate nature of the materials that form the wafer, but also because of the weights of the mounted, bonded, attached, or otherwise connected elements that are associated with the wafers. Further, the coefficients of thermal expansion (CTE) can be different for various materials in a typical wafer stack-up, leading to a variety of failures after power is applied. The application of power results in non-uniform expansion between elements. The non-uniform expansion can cause fractures, disconnects, and other failures. Finally, various connections to the wafer must be manufactured without rupturing other existing connections. In a usage example, an oven typically used for a reflow process can damage chip connections, such as controlled collapse chip connections (C4s) that were previously formed. Thus, proper support and stabilization of, power delivery to, connections to, and heat removal from the wafers have become paramount to prevent wafer damage or wafer failure.

Disclosed techniques enable back side power delivery for wafer-scale integration with laser-assisted bonding. A wafer-scale integration interposer (WSII) is accessed. A front side of the WSII is bonded to a plurality of chiplets. The WSII includes through-silicon vias (TSVs). Modular power substrates (MPSs) are bonded to a back side of the WSII. The bonding is accomplished via laser-assisted bonding (LAB). The MPSs are coupled electrically to a plurality of DC-to-DC power converters. The plurality of DC-to-DC power converters sends DC power to the plurality of chiplets. The sending is based on the plurality of MPSs and the plurality of TSVs.

A method for power delivery is disclosed comprising: accessing a wafer-scale integration interposer (WSII), wherein a front side of the WSII is bonded to a plurality of chiplets, wherein the WSII includes a plurality of through-silicon vias (TSVs); bonding, to a back side of the WSII, a plurality of modular power substrates (MPSs), wherein the bonding is accomplished via laser-assisted bonding (LAB); coupling electrically the plurality of MPSs to a plurality of DC-to-DC power converters; and sending DC power, by the plurality of DC-to-DC power converters, to the plurality of chiplets, wherein the sending is based on the plurality of MPSs and the plurality of TSVs.

Various features, aspects, and advantages of various embodiments will become more apparent from the following further description.

### BRIEF DESCRIPTION OF THE DRAWINGS

The following detailed description of certain embodiments may be understood by reference to the following figures wherein:

FIG. 1 is a flow diagram for back side power delivery for wafer-scale integration with laser-assisted bonding.

FIG. 2 is a flow diagram for maintaining coplanarity.

FIG. 3 shows a wafer with multiple die.

FIG. 4 illustrates inter-die interconnect for wafer-scale integration.

FIG. 5 shows inter-die interconnect with redundancy for wafer-scale integration.

FIG. 6 illustrates a flip-chip and interposer with flip-chips for wafer-scale integration.

FIG. 7 in an example of laser-assisted bonding.

FIG. 8 is a diagram of a modular power substrate (MPS).

FIG. 9 is a diagram of an isometric grid array.

FIG. 10 illustrates a cross-section for a photonic wafer-scale interposer (PWSI) with chiplets.

FIG. 11 is a cross-section of an apparatus for back side power delivery for wafer-scale integration with laser-assisted bonding.

FIG. 12 is a system diagram for back side power delivery for wafer-scale integration with laser-assisted bonding.

### DETAILED DESCRIPTION

Techniques using back side power delivery for wafer-scale integration with laser-assisted bonding are disclosed. Demand for significant processing performance improvements has soared. The demand directly correlates with the development of new applications for processors, multiprocessors, accelerators, and so on. This demand forces chip designers and chip architects to develop next generation chips that can provide increased processing power to computers, servers, cloud servers, large language model (LLM) engines, etc. To meet these demands, immense numbers of transistors have been added to a wide variety of chips such as systems-on-chip (SOCs). SOCs can include a vast range of circuitry which can comprise processors, memories, input/output (I/O) circuits, network switches, and other elements. These SOCs can be dimensionally large, possessing tens of billions of transistors. At the same time, the feature sizes of the transistors used for these large chips continue to shrink. In fact, according to Moore's law, the number of transistors that can fit into the same size chip should double every two years. While at some point, this doubling will likely end as the limits of lithography and physics are approached, in general, the “law” has held true for the last several decades. Keeping chip sizes roughly the same size while increasing transistor count is generally good news, but new technologies that drive smaller transistors also impose new challenges for designers. For example, as a transistor shrinks, leakage currents typically increase, driving larger power consumption for and corresponding heat generation from the chip. These effects, in combination with the active power required for billions of transistors, can drive extremely high-power densities for processors and other computing elements. Further, the wafers on which these large chips are fabricated are delicate. The wafers can fracture if the wafers are not properly handled and supported.

The ever-increasing interest in and use of artificial intelligence (AI) applications, such as large neural networks, transformers, and so on, can require hundreds or even thousands of processing elements. The processing elements handle, in some cases, trillions of computations required by the AI applications. These processing elements can include processor cores, multiprocessor cores, matrix computation accelerators, SOCs, ASICs, and so on. While multiple cores such as processor cores and memory cores can be included on the same chip, many chips, and thus, many processors, are required for executing these computationally intensive applications. The processing chips are routinely in communication with other processing chips that are located ideally locally, but also remotely. The processing chips are typically coupled via cards, data racks, and data centers. The chips, when taken together, introduce significant design challenges such as the provision of power to the chips, the cooling of all these chips, etc. For example, cooling has become a particularly complex challenge, especially when thermal design power (TDP), a measurement of the maximum power consumed by a chip under normal operating conditions, continues to increase.

Techniques and technologies are actively being developed that improve performance of AI applications and models. One technique, wafer-scale integration, is an approach that holds great promise to address the highly demanding performance requirements, with a particular focus on the data transfer bandwidth requirements of AI and other applications. Wafer-scale integration can include fabricating a monolithic wafer with any number of chips or using a wafer as an interposer to couple many chiplets. The chips can include AI accelerators; processors and multicore processors; SOCs; application-specific integrated circuits (ASICS); memory chips such as SDRAM, DDR1, DDR2, DDR3, DDR4, DDR5 and high bandwidth memory (HBM); and so on. The chiplets can be coupled by wiring paths on and within the wafer interposer. The wafer interposer can be processed using a back-end-of-line (BEOL) wafer process which can include any number of metal layers. These metal layers can be used to couple any AI accelerator to any memory controller on the interposer. The wafer metal layers can provide extremely high bandwidth communication between any element included on the interposer such as memory controllers, AI processors, etc., due at least in part to short communications paths. While such technology can address the performance challenges associated with extremely compute-intensive and high bandwidth applications such as AI acceleration, concerns exist for their use in production. For example, a wafer interposer can be brittle and difficult to handle, especially with a plurality of chiplets bonded to a front side of a WSII and other elements bonded to a back side of a WSII. Further, the coplanarity of the wafer interposer can vary, resulting in less-than-optimal electrical connections across the front side and back side of the wafer interposer. Grinding of the interposer, which can enable technologies such as through-silicon vias (TSVs), can thin the wafer interposer, making it still more difficult to handle without cracking. A further challenge arises in the connections between all layers of the wafer-scale integration (WSI) system. For example, chips on the top of the interposer can be mounted using flip-chip techniques via controlled collapse chip connections (C4s), microbumps, and so on to the interposer. However, for delivering power, larger DC power transformers often require soldering to the back side of the interposer. The soldering process can include an oven which can crack or destabilize other C4s or microbumps attached to the interposer. A further complication is the difference in the thermal coefficient of expansion between a typical WSI stack-up, causing various elements to expand at different rates as temperatures rise due to operation. This can cause additional failures within a system. These issues present a substantial technical challenge for the handling, assembly, and operation of wafer interposers.

To address the significant risks while providing power to the wafer-scale integration interposer described above, back side power delivery for wafer-scale integration with laser-assisted bonding is disclosed. A wafer-scale integration interposer (WSII) is accessed. In embodiments, the WSII comprises a wafer-scale silicon interposer (WSSI). A front side of the WSII is bonded to a plurality of chiplets. The WSII includes a plurality of through-silicon vias (TSVs). The TSVs provide connectivity between a front side of the WSII and a back side of the WSII. A plurality of modular power substrates (MPSs) is bonded to a back side of the WSII. The bonding is accomplished via laser-assisted bonding (LAB). The laser used for the laser-assisted bonding can include a laser diode, a blue laser, and so on. The laser used for the LAB can accurately pinpoint heating of a solder ball such as one or more micro bumps, one or more controlled collapse chip connections (C4s), solder balls within a ball grid array, etc. The LAB forms a strong solder connection between each MPS and the WSII at each solder ball point. The plurality of MPSs is coupled to a plurality of DC-to-DC power converters. The plurality of DC-to-DC power converters comprises a unified control board (UCB). The DC-to-DC converters can convert a DC voltage from a first DC voltage to a second DC voltage. The plurality of DC-to-DC power converters sends DC power to the plurality of chiplets. The sending of the DC power to the plurality of chiplets is based on the plurality of MPSs and the plurality of TSVs.

The plurality of MPSs is coupled electrically to a unified control board (UCB). The electrical coupling is based on a plurality of high power sockets. The high-power sockets can include high power DC sockets. The UCB includes a plurality of DC-to-DC power converters. The DC-to-DC power converters can convert a higher DC voltage to a lower DC voltage. The lower voltage can enable operation of the chiplets on the WSII. DC power is sent, by the UCB, to the plurality of chiplets. The sending is based on the plurality of DC-to-DC power converters, the plurality of MPSs, and the plurality of TSVs. The sending includes delivering the DC power, by the UCB, to the plurality of MPSs. The delivering includes a first voltage conversion. The DC power that was delivered, by the plurality of MPSs, is transferred to the plurality of chiplets. The transferring includes a second voltage conversion. The second voltage conversion can produce a DC voltage below a threshold such as 1 volt.

A cold plate can be attached to the plurality of chiplets to cool the chiplets. The attaching can include a thermal interface material (TIM). The cold plate comprises an inlet plate, a jet-plate, and a fin-plate. Coolant at a first temperature can be sent into at least one inlet nozzle located on the inlet plate. The sending can include spraying the coolant, by the jet-plate, on the fin-plate. At least a portion of the heat that was created by the chiplets and other electronic elements can be transferred, by the cold plate, to the coolant that was sent. The coolant can be captured, at a second temperature, from one or more outlet chambers within the jet-plate.

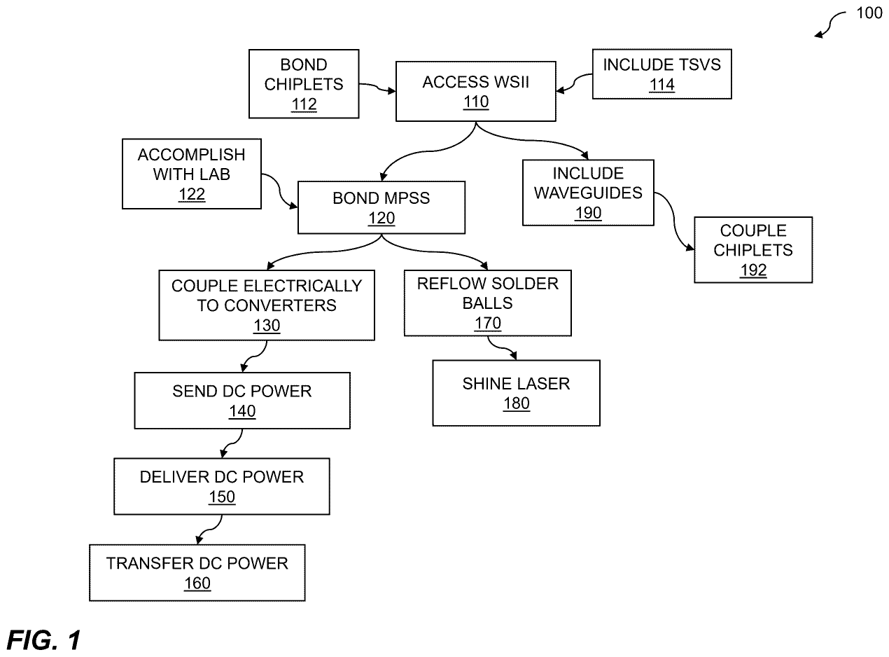

FIG. 1 is a flow diagram for back side power delivery for wafer-scale integration with laser-assisted bonding. The flow 100 includes accessing a wafer-scale integration interposer (WSII) 110. Wafer-scale integration has been a long sought goal of integrated circuit design. One objective of wafer-scale integration is that an entire wafer such as a silicon wafer (which can be a monolithic wafer) could be used to fabricate one large integrated circuit. However, since physical defects in the silicon wafer are distributed across the wafer, portions of circuitry which were fabricated over the defects would likely not function properly. In addition, errors that occur when fabricating the many layers that form the integrated circuit could further cause portions of the integrated circuit to likely not function. Instead, by attaching or bonding a plurality of integrated circuits to the WSII, wafer-scale integration can be achieved. This technique can further allow chips from different manufacturing processes to be included in the wafer-scale integration. In this case, the wafer can be used as an interposer to couple the various integrated circuits. The wafer can be a 300 mm wafer, a 200 mm wafer, or a wafer of another size. The wafer can comprise silicon or another suitable material. In a usage example, another suitable material can include glass. The wafer can include any amount of front-end-of-line (FEOL) processing and/or back-end-of line (BEOL) processing. The processing can be based on Complementary Metal-Oxide-Semiconductor (CMOS), Silicon on Insulator (SOI), Gallium Nitride (GaN), or another process.

In the flow 100, a front side of the WSII is bonded to a plurality of chiplets 112. The WSII can have a front side and a back side onto which elements such as the electronic circuit elements can be attached, bonded, mounted, coupled, etc. The chiplets can include general purpose chiplets, such as processor chiplets, multiprocessor chiplets, graphics processor chiplets, application-specific integrated circuits (ASICS), memory chiplets, switching chiplets, I/O chiplets, and so on. In a usage example, the plurality of chiplets includes one or more artificial intelligence (AI) accelerators. The AI accelerators can be used for applications such as machine learning; natural language processing; image, video, and audio processing; etc. In another usage example, the plurality of chiplets includes one or more memory devices. The plurality of chiplets can include one or more application specific integrated circuits (ASICS); one or more systems-on-chip (SOCs); optical components such as vertical-cavity surface-emitting lasers (VCSELS); and so on. In the flow 100, the WSII includes a plurality of through-silicon vias (TSVs) 114. A TSV can include an electrical connection that completely passes through a wafer such as a silicon wafer, a glass wafer, a die cut from a wafer, and so on. The plurality of TSVs can be oriented vertically in order to enable connections between the front side of the wafer and the back side of the wafer. Chips such as the chiplets can be positioned such that connections to the chips align with the TSVs. In some examples, a wafer can be ground to enable TSV processing with repeatable shapes and parasitic characteristics.

In exemplary implementations, the WSII can comprise a monolithic wafer. The monolithic wafer can include a plurality of functional cores that are fabricated on the wafer. The functional cores can include one or more processors, AI accelerators, ML accelerators, ASICS, peripheral interfaces, and so on. The functional cores can include memory. Other memory elements, such as SRAM, DRAM, etc., can be included in the monolithic wafer. The memory elements can also be fabricated on the wafer. Interconnect can be included on the monolithic wafer to couple any number of the functional cores, memory elements, and so on. The interconnect can comprise any number of metal layers on the wafer.

The flow 100 includes bonding 120, to a back side of the WSII, a plurality of modular power substrates (MPSs). A modular power substrate can include one or more electrical elements, DC-to-DC power converters, control signals, connectors, and so on. In the flow 100, the bonding is accomplished 122 via laser-assisted bonding (LAB). The laser-assisted bonding can be based on one or more types of lasers, such as a diode laser, a blue laser, and so on. In embodiments, the LAB comprises reflowing, by a laser, one or more solder balls, wherein the bonding is based on the one or more solder balls that were reflowed. The solder balls can be reflowed individually, in groups, and the like. The solder balls that can be reflowed can include microbumps, solder balls arranged in an array such as a ball grid array (BGA), etc. In embodiments, the one or more solder balls comprise controlled collapse chip connections (C4s). Further embodiments can include inserting each MPS within the plurality of MPSs that was bonded into an isometric grid array (IGA), wherein the IGA includes a plurality of open recesses. The open recesses can include round recesses, square recesses, and so on. In embodiments, the plurality of open recesses comprises a grid. The walls of the open recesses can fit between the MPSs. In embodiments, the IGA contacts the back side of the WSII between each MPS in the plurality of MPSs that were bonded. The contacting the WSII by the IGA can enable stiffening of the WSII and can provide support to the WSII. Each open recess within the plurality of open recesses within the IGA can match a form factor of each MPS in the plurality of MPSs. By matching a form factor of each MPS, the IGA can provide support to each MPS. In embodiments, each MPS within the plurality of MPSs is based on a form factor mirroring one or more corresponding chiplets within the plurality of chiplets. Mirroring a form factor of one or more corresponding chiplets can accommodate differences in coefficients of thermal expansion (CTEs) between the MPSs and the chiplets, thereby reducing risk of fracturing the WSII due to the different CTEs of the WSII, the IGA, and other elements.

The flow 100 includes coupling electrically 130 the plurality of MPSs to a plurality of DC-to-DC power converters. The electrical coupling can be accomplished using a connector such as a high power socket, connector, pins, terminal, cables, and so on. The electrical coupling can be configured to transfer a substantial DC current at an appropriate DC voltage. The MPSs can include electrical elements, contacts and connectors, and so on. The electrical elements associated with the MPSs can include DC-to-DC converters. The DC-to-DC converters can be arranged across a given MPS. The DC-to-DC converters can be stacked. Any number of voltage conversions can be included so that the chiplets receive power at an appropriate operating voltage. In a usage example, a first voltage conversion is accomplished by the plurality of DC-to-DC power converters. The connectors can include a high power connector. The substrate associated with an MPS to which the electrical elements, connectors, and so on are mounted can include a variety of materials. One or more MPSs within the plurality of MPSs can comprise an organic substrate. An organic substrate can be based on organic materials such as organic materials used to manufacture printed circuit boards. The organic substrate materials can include paper cores impregnated with phenolic resin, woven or unwoven grass cloth impregnated with epoxy or cyanate ester among others, natural fibers, etc. One or more MPSs within the plurality of MPSs can comprise an inorganic substrate. An inorganic substrate can be based on silicon, glass with a similar coefficient of expansion to the MPS, etc.

In embodiments, the plurality of DC-to-DC power converters comprise a unified control board (UCB), wherein the coupling electrically is based on a plurality of high power sockets. In a usage example, the UCB comprises a printed circuit board (PCB). The UCB can include one or more materials. The materials associated with the UCB can include inorganic substrate materials, organic substrate materials, and so on. The organic substrate materials can include paper cores impregnated with phenolic resin, woven or unwoven grass cloth impregnated with epoxy or cyanate ester among others, natural fibers, FR-4, FR-5, etc. In a further usage example, one or more MPSs within the plurality of MPSs can include an inorganic substrate. The inorganic substrate materials can be based on a silicon glass. In another usage example, the PCB comprises ceramic. The ceramic associated with the PCB can include a coefficient of thermal expansion (CTE) similar to the WSII or other components. Similar CTEs can help to limit differences in lateral movement between layers due to heat during operation. For example, aluminum nitride can have a CTE that is close to silicon. In embodiments, the PCB comprises aluminum nitride. A PCB can perform well in circuit applications where the circuits require high current and generate substantial heat.

Discussed above, each MPS within the plurality of MPSs can be based on a form factor mirroring one or more corresponding chiplets within the plurality of chiplets on the front side of the WSII. The form factor can be based on one or more parameters associated with the one or more corresponding chiplets. In a usage example, the form factor can be based on a coefficient of thermal expansion (CTE). The chiplets can generate copious heat while operating. Physical components such as substrates, WSIIs, etc. can expand when heated based on a coefficient of thermal expansion associated with each material. A coefficient of thermal expansion of the UCB can be different than a coefficient of thermal expansion of the IGA, the WSII, and so on. The difference in expansion coefficients can cause connectors to disconnect, C4s to crack, physical strain within materials that can cause damage, etc. Thus, if the UCB is directly mechanically connected to a WSII, the lateral displacement due to differences in thermal expansion can cause mechanical failure. Choosing an appropriate form factor for the MPSs can reduce risks of fracturing the WSII due to differing CTEs associated with the chiplets bonded to the front side of the WSII and the MPSs coupled to the back side of the WSII. Further, the modularity of the MPSs can provide a flexible power delivery system to the chiplets which can accommodate different movements of the WSII and UCB due to thermal expansion. For example, an MPS at one side of the WSII can be decoupled from an MPS on the other side of the WSII, thus accommodating various movements across the WSII and UCB. Further, compliant connectors can be used to better tolerate lateral displacement caused by CTE differences. By attaching the plurality of MPSs to the back side of the WSII instead of the front side of the WSII, heat mitigation techniques can be applied to the front side of the WSII.

The flow 100 includes sending DC power 140, by the plurality of DC-to-DC power converters, to the plurality of chiplets, wherein the sending is based on the plurality of MPSs, and the plurality of TSVs. The DC-to-DC converters can convert a DC voltage from a first DC voltage to a second DC voltage. The second DC voltage can be higher than the first DC voltage (e.g., a boost converter), or the second DC voltage can be lower than the first DC voltage (e.g., a buck converter). Recall that the plurality of chiplets is bonded to the front side of the WSII. Recall also that the DC-to-DC converters can comprise a UCB. The sending power can be further based on converting one or more DC voltages. Embodiments include delivering the DC power 150, by the UCB, to the plurality of MPSs, wherein the delivering includes a first voltage conversion. In a usage example, the first voltage conversion can include converting a voltage in a range such as 48 volts to 54 volts to a voltage in a lower range such as 12 volts to 13.5 volts. The first voltage conversion can be controlled by the control circuits included on the UCB. Embodiments include transferring the DC power 160 that was delivered, by the plurality of MPSs, to the plurality of chiplets, wherein the transferring includes a second voltage conversion. The second voltage conversion can convert a voltage to a voltage below a threshold. The second voltage conversion can change the voltage that the chiplets receive to an appropriate operating level, such as less than 1 volt. The transferring can be based on a plurality of MPSs that can be bonded to the back side of the WSII. The second voltage conversion can be controlled by the control circuits included on the UCB. Chips such as the chiplets can be positioned such that connections to the chips align with the TSVs. In some examples, a wafer can be ground to enable TSV processing with repeatable shapes and parasitic characteristics.

In the flow 100, the LAB comprises reflowing 170, by a laser, one or more solder balls, wherein the bonding is based on the one or more solder balls that were reflowed. The LAB can be used to reflow solder balls, where the solder balls can include microbumps, controlled collapse chip connections (C4s), solder balls within a ball grid array (BGA), and the like. The solder balls that are reflowed can provide a mechanically strong, electrically reliable bonding of the plurality of MPSs to the WSII. In the flow 100, the reflowing comprises shining the laser 180 through a front side of the WSII. Various types of lasers can be used to accomplish reflow of a microbump, a solder bump, a controlled collapse chip connections (C4), a ball grid array (BGA), and so on. The laser can include a laser diode such as a laser line diode, a blue laser, and the like. The laser can be directed up through the top of the wafer-scale integration interposer. By accomplishing the reflowing using a laser rather than a reflow oven, the integrity of earlier soldering steps and other fabrication steps such as diffusion can be maintained.

In some embodiments, the WSII comprises a photonic wafer-scale interposer (PWSI), wherein the PWSI includes a plurality of waveguides, wherein a first chiplet within the plurality of chiplets is coupled with a second chiplet within the plurality of chiplets, based on a first waveguide within the plurality of waveguides. The PWSI can be bonded to various types of chiplets as described above. The PWSI can further be connected to optical elements, optical chiplets, photonic elements, and so on. In the flow 100, the PWSI includes a plurality of waveguides 190. The plurality of waveguides can be fabricated within the PWSI and can provide high speed communication between chiplets. In a usage example, the plurality of waveguides can be fabricated using a silicon-on-insulator (SOI) technique. In the flow 100, a first chiplet within the plurality of chiplets is coupled with a second chiplet 192 within the plurality of chiplets based on a first waveguide within the plurality of waveguides.

The PWSI can include elements that support a specific processing application. In other embodiments, the PWSI comprises an optical wafer-scale network switch, wherein one or more chiplets in the plurality of chiplets comprise one or more switching chiplets. In a usage example, the plurality of chiplets that can be bonded to the PWSI can include optical chips such as VCSELs. The wafer-scale network switch can be configured to handle complex and/or numerous data transfer requests associated with applications such as AI and ML. In embodiments, the PWSI comprises an optical wafer-scale AI accelerator, wherein one or more chiplets in the plurality of chiplets comprise one or more artificial intelligence (AI) accelerators.

A chiplet such as the first chiplet can be coupled to a light source, where the light source can include a surface-emitting light source. The surface-emitting light source can include an LED light source, a vertical-cavity surface emitting laser (VCSEL), and so on. The surface-emitting light source can be used to generate optical data such as optical serial data from digital data such as digital serial data. Thus, data can be sent by a first chiplet to a second chiplet. The sending can be based on a first waveguide within the plurality of waveguides. The waveguide can include one or more confinement regions. The waveguide can include a transition between confinement regions associated with the waveguide. The second chiplet receives the data that was sent. The received data can be reconverted from optical data to digital data.

The WSII can be brought in contact with a cold plate. The cold plate can contact the plurality of chiplets bonded to the front side of the WSII. The cold plate can be used to remove at least a portion of the heat generated by the chiplets while the chiplets are operating. The mounting can include mounting the cold plate to the IGA. The mounting the IGA to the cold plate can be accomplished using screws, bolts, clips, and so on. In embodiments, the mounting is based on one or more spring-loaded fasteners. The mounting can be based on one or more clamps. Thus, the WSII can be held between the cold plate and the places where the WSII contacts the IGA. The holding can apply pressure on the WSII from the top and the bottom, stiffening the WSII and maintaining coplanarity.

The IGA can comprise a compression plate. Recall that the IGA can comprise a grid. In embodiments, each open recess within the plurality of open recesses within the IGA matches a form factor of each MPS in the plurality of MPSs. An MPS can be inserted into the IGA. As described above, the back side of the MPS can be bonded to the WSII via one or more solder bumps. Inclusion of the IGA can be useful because the WSII can be thin. The WSII, especially when ground or polished to accommodate TSVs, can be fragile. The IGA can thus provide support for the WSII by enhancing stability, increasing stiffness, reducing the chance of fracturing, enabling better electrical connections across the WSII, etc. Thus, the IGA maintains a coplanarity of each MPS in the plurality of MPSs.

In embodiments, the cold plate comprises an inlet plate, a jet-plate, and a fin-plate. The inlet plate can receive a liquid such as a liquid coolant. In embodiments, an inlet nozzle within the inlet plate is located orthogonally to a heat extraction plane within the fin-plate. The jet-plate can create a spray which can be sprayed onto the fin-plate based on holes in the jet-plate. The holes in the jet-plate can include holes of substantially similar sizes or of different sizes. The holes can concentrate a spray onto a region of the fin-plate covering the chiplets. In a usage example, holes toward the center of the jet-plate can be smaller than the holes toward the outer edges of the jet-plate to account for liquid pressure differences across the jet-plate. The fin-plate can include a plurality of internal fins onto which the jet-plate sprays a liquid coolant. The fins can increase the surface area of the fin-plate, thereby enhancing removal of heat from the chiplets to which the fin-plate is attached.

The cold plate provides liquid cooling for the plurality of chiplets. The liquid can include a coolant where the coolant can be distilled water or another liquid. The coolant can be mixed with additives such as glycol. In a usage example, attaching the cooling plate includes a thermal interface material (TIM). The TIM can conduct heat between surfaces, thus enabling more efficient cooling solutions. The TIM can comprise thermal tape, grease, gel, adhesive, phase change materials (PCMs), metal TIMs, pyrolytic graphite, and so on. In a usage example, the TIM can include an uncured TIM. The uncured TIM can remain flexible or viscous, thereby enabling the cold plate and the chiplets to expand by different lateral displacements based on different coefficients of thermal expansion.

Various steps in the flow 100 may be changed in order, repeated, omitted, or the like without departing from the disclosed concepts. Various embodiments of the flow 100 can be included in a computer program product embodied in a non-transitory computer readable medium that includes code executable by one or more processors.

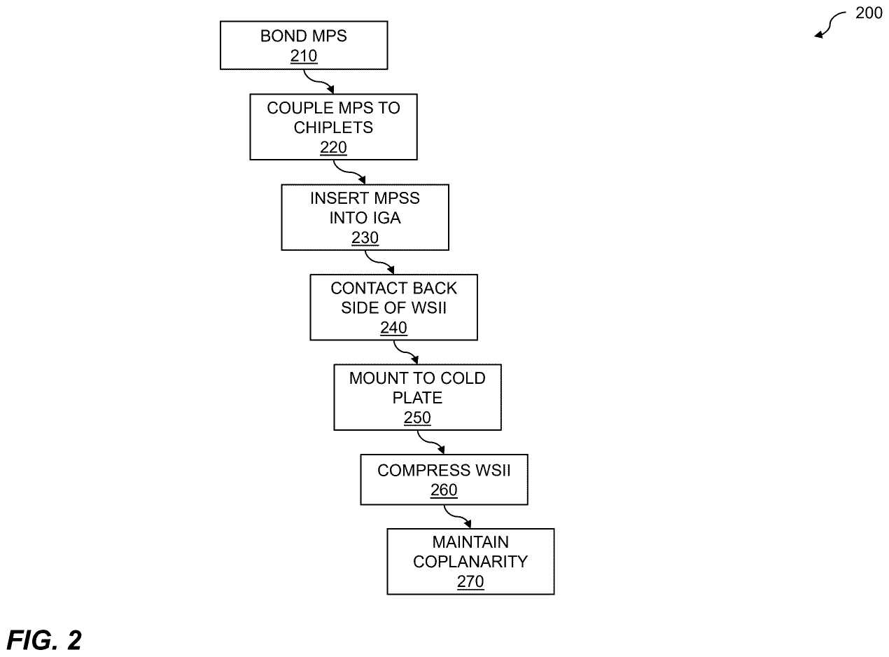

FIG. 2 is a flow diagram for maintaining coplanarity. Discussed previously and throughout, wafer-scale integration (WSI) can be accomplished using a wafer-scale integration interposer (WSII). The WSII can include a silicon wafer, a glass wafer, and so on. A top side of the interposer can be bonded to a plurality of chiplets. The chiplets can include processors, multiprocessors, artificial intelligence accelerators, machine learning accelerators, memories, switches, and so on. The chiplets must be provided power such as DC power in order for the chiplets to operate. Modular power substrates (MPSs) can be bonded to a back side of the WSII, where the bonding is accomplished via laser-assisted bonding (LAB). The LAB can be used to reflow solder balls, where the solder balls can include microbumps, controlled collapse chip connections (C4s), solder balls within a ball grid array (BGA), and the like. The solder balls that are reflowed can provide a mechanically strong, electrically reliable bonding of the plurality of MPSs to the WSII.

Power to the chiplets can be provided by coupling the plurality of modular power substrates (MPSs) to a unified control board (UCB). The UCB can include DC-to-DC converters that can convert a DC voltage to a first DC voltage. The MPSs can further include DC-to-DC converters that can convert the first DC voltage to a second DC voltage. By bonding the plurality of MPSs to a back side of the wafer-scale interposer, the DC power can be provided by the MPSs on the back side of the interposer to the front side of the interposer using through-silicon vias (TSVs). Further, the above-mentioned methods and materials can enable bonding without the risks of soldering techniques, such as wave soldering. Wave soldering applies sufficient heat to the WSII and associated chiplets and MPSs to melt the solder ball. Such heating can bend, crack, weaken, etc. existing connections such as solder bumps, C4s, and so on.

Chiplets can be bonded to a wafer-scale integration interposer (WSII). The use of the WSII supports wafer-scale integration (WSI), which is particularly useful to supporting the processing requirements of computationally intensive applications such as artificial intelligence (AI) acceleration. The chiplets that execute the computationally intensive applications require significant amounts of power during operation. The power, which includes DC power, must be sent or transferred to the chiplets. The power can be provided using modular power delivery techniques. A WSII can be brittle and difficult to handle, especially with a plurality of chiplets bonded to a front side of the WSII. Further, the coplanarity of the WSII with respect to the UCB can vary, resulting in less-than-optimal electrical connections across the front side and back side of the WSII. Additionally, to support of reliable manufacture of the TSVs, the interposer can be ground and/or polished to a thinness that can support fabrication of the TSVs. This technique can thin the wafer, making it more difficult to handle without fracturing, especially with the additional weight of front side chiplets.

Thus, the WSII can be supported or stiffened in order to protect the interposer from fracturing. An isometric grid array (IGA) can accomplish supporting the WSII. The IGA can include a compression plate. The stiffening can be accomplished by inserting each MPS within the plurality of MPSs that was bonded into an isometric grid array (IGA), wherein the IGA includes a plurality of open recesses. The open recesses within the IGA can include round recesses, square recesses, honeycomb recesses, and so on. The open recesses can include a pattern such as a grid pattern. The MPSs can be inserted into the recesses of the IGA, enabling the IGA to contact the back side of the WSII between each MPS in the plurality of MPSs that were bonded. The IGA can thus enable stiffening of the WSII. The WSII can be compressed, where the compressing is based on the mounting of the IGA to the WSII. The compressing maintains a coplanarity of the WSII. The stiffening can enable planar compression of the MPSs, and thus planar compression of conductive connecting materials, such as elastomer sheets, ACFs, or ICAs, used to couple the MPSs to the WSII. The conductive connecting materials further provide conduction paths between the MPSs and the WSII. The IGA can also reduce the risk of fracturing of the WSII during handling, assembly, functional operation, and so on. The stiffening of the WSII enables back side power delivery for wafer-scale integration with laser-assisted bonding.

The flow 200 includes bonding 210, to a back side of the WSII, a plurality of modular power substrates (MPSs), wherein the bonding is accomplished via laser-assisted bonding (LAB). Recall that the MPSs can include one or more DC-to-DC converters, a high voltage socket, a high voltage connector, and so on. In embodiments, each MPS within the plurality of MPSs is based on a form factor mirroring one or more corresponding chiplets within a plurality of chiplets on the front side of the WSII. The laser-assisted bonding can be based on one or more types of lasers, such as a diode laser, a blue laser, and so on. The laser-assisted bonding can be accomplished by reflowing one or more solder balls, where the solder balls can be reflowed individually, in groups, and the like. Embodiments include coupling each MPS within the plurality of MPSs to one or more chiplets 220 within the plurality of chiplets, wherein the coupling includes one or more TSVs within the plurality of TSVs. The MPS can be coupled to the chiplets via LAB. Each MPS can provide DC power to one or more chiplets. The MPSs can be physically arranged to mirror a single chiplet. The IGA can accommodate such positioning.

The flow 200 includes inserting 230 each MPS within the plurality of MPSs that was bonded into an isometric grid array (IGA), wherein the IGA includes a plurality of open recesses. The open recesses can be organized in a variety of patterns. In embodiments, the plurality of open recesses comprises a grid. The open recesses can be based on one or more shapes such as squares, rectangles, circles, hexagons, etc. In the flow 200, the IGA contacts 240 the back side of the WSII between each MPS in the plurality of MPSs that were bonded. The IGA contacting the back side of the WSII provides support and stiffening to the WSII. Recall that the WSII can be ground and polished to a thin dimension in order to support fabrication of the TSVs. The resulting, thin WSII is fragile and prone to fracture. The IGA contacting the back side of the WSII provides support to the WSII by stiffening the WSII.

The flow 200 further includes mounting 250 the IGA to a cold plate, wherein the cold plate contacts the plurality of chiplets bonded to the front side of the WSII. The cold plate can be used to remove a portion of the excess heat generated by the plurality of chiplets bonded to the front side of the WSII. The mounting can be based on screws, bolts, clips, and so on. In embodiments, the mounting is based on one or more spring-loaded fasteners. Other fastening techniques can also be used. In embodiments, the mounting is based on one or more clamps. The spring-loaded fasteners and/or the one or more clamps can be configured to provide sufficient force to maintain attachment of the plurality of the MPSs to a back side of the WSII. Described previously, the cold plate provides liquid cooling based on distilled water or another liquid for the plurality of chiplets. The coolant can be mixed with additives such as glycol. In embodiments, the attaching includes a thermal interface material (TIM). The TIM can conduct heat between surfaces, thus enabling more efficient cooling solutions. The TIM can comprise thermal tape, grease, gel, adhesive, phase change materials (PCMs), metal TIMs, pyrolytic graphite, and so on. In a usage example, the TIM can include an uncured TIM. The uncured TIM can remain flexible or viscous, thereby enabling the cold plate and the chiplets to expand by different lateral displacements based on different coefficients of thermal expansion.

The flow 200 includes compressing 260 the WSII, wherein the compressing is based on the mounting, and wherein the compressing maintains a coplanarity 270 of the WSII. The WSII can be compressed between the cold plate and the isometric grid array. The compressing can be accomplished by clipping, clamping, preloading, and so on. In embodiments, the compressing is based on the one or more spring-loaded fasteners. The compressing can be based on one or more clamps which can provide more compression force than the spring-loaded fasteners. In the flow 200, the compressing maintains a coplanarity of the WSII. The coplanarity of the WSII reduces risk of cracking or fracturing the WSII. The coplanarity can enable reliable connections to the WSII without causing the PWSI to deflect, fracture, and so on.

Power is sent by the plurality of DC-to-DC power converters, which can comprise a unified control board (UCB), to the plurality of chiplets bonded to the front side of the WSII that was stiffened by the IGA. The sending DC power can be accomplished using an interposer associated with a wafer-scale integration interposer (WSII). The WSII can include layers of interconnect fabricated on a front side and a back side of the WSII. The interconnect can include vias such as through-silicon vias (TSVs). The TSVs can provide connections directly between the front side of the WSII and the back side of the WSII. In embodiments, the sending DC power is based on the plurality of MPSs and the plurality of TSVs. The sending can include delivering the DC power, by the UCB, to the plurality of MPSs. The delivering can be accomplished using the TSVs, WSII interconnect, and so on. The delivering DC power can be accomplished by the plurality of DC-to-DC converters included on the UCB. The delivering DC power can include delivering DC power to a subset of MPSs. The delivering DC power can be accomplished by matching one or more DC-to-DC converters to one or more MPSs. Interconnection between the DC-to-DC converters matched with one or more respective MPSs can be accomplished using interconnect associated with the UCB. The sending can be based on a DC voltage.

The DC power that is delivered can include a range for the DC voltage. The range of DC voltage can include a percentage of a target voltage, an allowable operating range of DC voltage, and the like. In a usage example, the voltage range can include 48 volts to 54 volts, inclusive. The delivering can include a first voltage conversion. The first voltage conversion can include a DC-to-DC voltage conversion. The result of the DC-to-DC voltage conversion can include a DC voltage higher than the input DC voltage or a DC voltage lower than the input DC voltage. The first voltage conversion can be accomplished using the one or more DC-to-DC converters. The DC-to-DC converters can include a plurality of DC-to-DC converters connected to the UCB.

The DC power that was delivered, by the plurality of MPSs, can be transferred to the plurality of chiplets. The plurality of chiplets can obtain the transferred power using interconnect, contacts, vias, and so on. The chiplets can also use interconnect and contacts to receive and send data, instructions, control signals, etc. The transferring can include a second voltage conversion. The second voltage conversion can be accomplished using one or more converters such as DC-to-DC converters associated with the MPSs. The second voltage conversion can produce a voltage that can be used directly to operate one or more chiplets. The second voltage conversion can attain a voltage less than the voltage resulting from the first voltage conversion. The second voltage conversion can result in a voltage less than a threshold. The threshold can include a target voltage, an operating voltage, and so on. In a usage example, the threshold is 1 volt. In a second usage example, the transferring can be based on the plurality of TSVs. The transferring can include transferring DC power, receiving and sending data, sending and receiving functional chip instructions and control signals, etc.

Various steps in the flow 200 may be changed in order, repeated, omitted, or the like without departing from the disclosed concepts. Various embodiments of the flow 200 can be included in a computer program product embodied in a non-transitory computer readable medium that includes code executable by one or more processors.

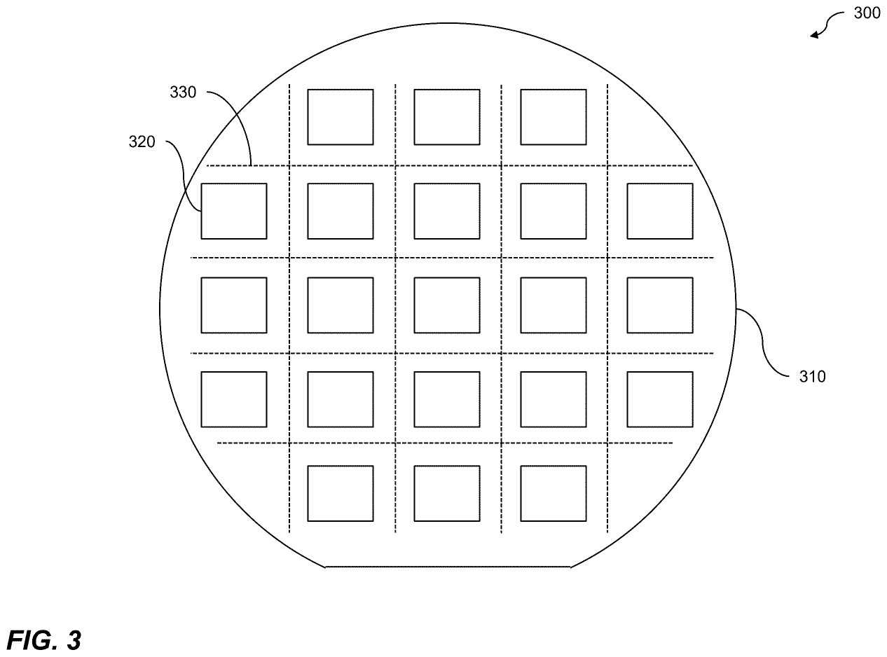

FIG. 3 illustrates a wafer with multiple die. A semiconductor wafer such as a silicon wafer is used in the fabrication of electronic circuits. Other semiconductor materials such as germanium, silicon carbide, indium phosphide, gallium nitride, etc. can also be used. The wafers that are used are obtained in various sizes. One common wafer includes a 300 mm silicon wafer. Integrated circuits such as chiplets can be fabricated on the surface of the wafer by implanting, depositing, removing, etc. various layers. The layers are applied to the wafer using techniques that can include diffusion, deposition, etching, planarization, and so on. The numbers of layers applied to the wafer can include dozens of layers, hundreds of layers, and so on. The layers can include active areas, polysilicon, metal, contacts, vias, and so on. The circuits are called “die” during fabrication. The die can include a plurality of similar circuits or can include two or more different circuits or “projects.” The similar circuits and the different projects can include processors, memories, mixed-signal chips, and so on. The multiple die that can be fabricated on the semiconductor wafer can include accelerators for artificial intelligence and machine learning. The multiple die can be used to enable back side power delivery for wafer-scale integration with laser-assisted bonding. A laser can be used to reflow a microbump, controlled collapse chip connections (C4), a ball grid array (BGA), and so on. The laser can be directed up through the top of the wafer-scale integration interposer. By accomplishing the reflowing using a laser rather than a reflow oven, the integrity of earlier soldering steps and other fabrication steps such as diffusion can be maintained.

The FIG. 300 shows a wafer with multiple die. A wafer can be based on a monocrystalline semiconductor material. The semiconductor material can include a group IV material such as silicon, a group III-V material such as gallium arsenide, and so on. The die on the wafer shown are substantially similar in size. However, the die can be substantially different in size. A system can depend on a certain number of functional die. For instance, an artificial accelerator used for training a large language model (LLM) to be executed on a neural network (NN) can require a large number of functional die. The die can be comprised of AI accelerators, ML accelerators, and so on. Since a wafer will contain defects randomly distributed across the wafer, some of the die fabricated on the wafer will be affected by the wafer defects and will not function properly. By fabricating multiples of the die, the probability of fabricating at least one functioning chip increases. Further, because the presence or absence of circuits or die on the wafer can influence successful fabrication of a given die, a wafer can be “covered” with circuits for fabrication. Because of the shape of the wafer, which is typically round with at least one flat edge to aid alignment, some of the circuits may not be fully contained within the boundaries of the wafer. The resulting “partial” circuits or die will not function fully or at all. In some cases, the partial die may be usable in other applications.

A wafer is shown 310. The wafer can include multiple die such as die 320. The multiple die can be replicas of the same chip. In some cases, the multiple die can be different die, such as SRAM die. The die on the wafer can all be fabricated using the same fabrication technology. If any die requires different fabrication technologies, then that die must be fabricated on a different wafer. While 21 die are shown on the wafer, in practice any number of die can be present. The number of die will depend on the size of the wafer and the size of the die. When fabrication steps, of which there can be many, are completed, the die can be separated. The figure shows a plurality of dashed lines such as line 330. The dashed lines represent scribe lines or kerf associated with the wafer. A saw, a laser, etc. is used to slice the wafer into liberated, individual die. Since the saw or other cutting device has a finite width, some wafer material is lost due to the width of the saw or cutting device. As a result, any structures such as test structures used to track processing steps during fabrication are lost.

While multiple die are shown in the diagram, the desire to further push the size of individual die has continued at a rapid pace. As one reference point, a packaged processor chip that is larger than 35 mm on a side has become common. However, as die on a wafer become larger, the risk of individual die being impacted by defects in the wafer, or defects associated with any of the many fabrication steps, increases. How, then, could one produce even larger chips? One suggestion that has long been proposed is to use the “entire” wafer to form a single large chip or “super chip.” In addition to producing the one chip on the wafer, packaging could potentially be reduced since the packaging would involve the one chip instead of a typical suite of chips, where each chip requires its own packaging. Wafer-scale integration or WSI has been proposed as particularly well suited to applications that demand extensive data processing. Examples proposed that could benefit from WSI have included computer architectures appropriate for massively parallel supercomputers, and computationally intensive applications such as machine learning and deep learning. However, successful fabrication of a single chip across an entire wafer is an extremely difficult undertaking. Noted above, the widespread and random distribution of defects and other variations such as warpage across a wafer render the ability to build one “super-circuit” elusive. Also, circuit redundancy becomes a major design issue. Not only are redundant circuits that can be switched in to replace defective circuits necessary, but the locations of the redundant circuits are also critical. Note that the redundant circuits must be connected in place of the defective circuits, and that wiring on an integrated circuit is extremely expensive in terms of real estate. As a result, the placement of the redundant circuits must be carefully considered to conserve wafer real estate and to reduce wiring complexity.

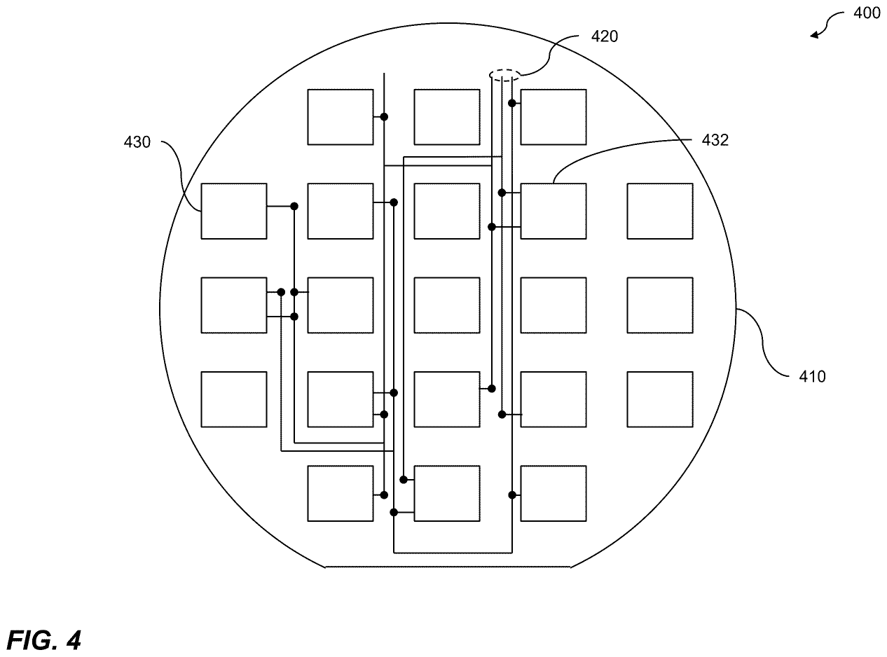

FIG. 4 illustrates inter-die interconnect for wafer-scale integration. Discussed previously and throughout, the demand for ever larger integrated circuits that can meet increasingly intensive processing demands has been stymied by the difficulty of producing large, single chips. One of the fundamental difficulties of producing a large chip, such as a wafer-sized chip, is that defects are randomly distributed across a wafer on which the large chip would be produced. Further, defects, such as disconnects in wiring, variations in oxide (insulator) thicknesses, open-circuit contacts, varying doping profiles, and so on, can be introduced during the fabrication process. One possible approach to “wafer-scale” integration is to continue to fabricate circuits on the wafer. Then, instead of cutting the wafer to access the individual die, the wafer remains whole. With this technique, the kerf, previously lost to the cutting of the wafer into the individual die, can be used for interconnect channels. Recall that interconnect on a wafer consumes wafer real estate that cannot otherwise be used for circuitry. By capturing the real estate previously lost to the kerf, additional wafer real estate that can be used for interconnect is captured. The interconnect in the kerf is particularly appropriate for long-haul connections, such as connections between individual die on the wafer. Since the wafer can be thinned during fabrication to enable vias, called through-silicon vias, to provide connections between a front side of the wafer and a back side of the wafer, the wafer can be reinforced. Back side power delivery for wafer-scale integration with laser-assisted bonding is enabled by inter-die interconnection.

The FIG. 400 illustrates use of wafer real estate, otherwise lost to scribe lines or kerf for inter-die interconnect, for wafer-scale integration. A wafer 410 is shown on which multiple die, or chips, are distributed. The die are fabricated together on the wafer. That is, each of the die on the wafer is fabricated based on the same processing steps. Since the individual die will not be separated from the wafer using a cutting technique, the kerf area of the wafer can be used for interconnect. Other areas of the die can also be used for interconnect. The interconnect 420 can be placed in wiring channels or routes, where the wiring channels are realized in what would formerly have been the kerf. The wiring channels include wafer real estate in which interconnecting wire can be placed. The interconnect can be fabricated while the various die on the wafer are fabricated. The interconnect can include a plurality of wiring layers. The various layers can be interconnected using contacts, vias, and so on. In the figure, a few example interconnecting runs are shown. The various die on the wafer can make connections to the wiring channels. In the figure, die 430 can use the wiring channels to connect to die 432.

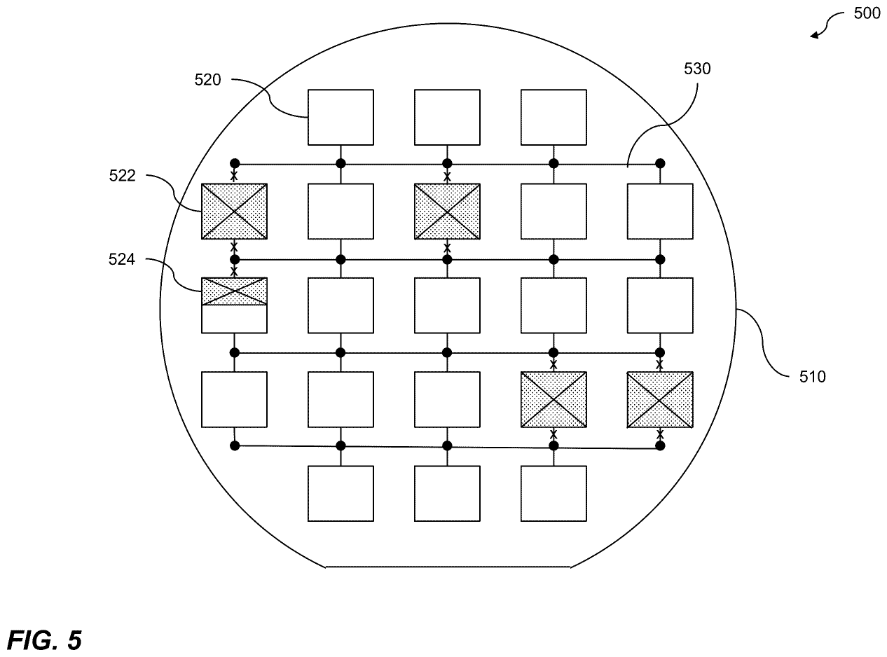

FIG. 5 shows inter-die interconnect with redundancy for wafer-scale integration. Building on the previous discussions of techniques including fabricating redundant die on a wafer and of using the kerf for interconnect, a technique for wafer-scale integration (WSI) can be based on fabricating redundant die on the wafer, and selecting the working die for use by a system based on WSI. Working die can be selected while non-working die, partial die, and other substandard die can be electrically ejected from the system by deselecting the die. The deselecting can include disabling wired connections to the unused die, physically “blowing” connections to the unused die (e.g., a fuse), and so on. The remaining functioning die can be interconnected using inter-die interconnect to form a system on the wafer. The system on the wafer can achieve the desired objective of wafer-scale integration. Power, data, control signals, and so on can be provided to the selected, working die. Due to the size of the wafer on which the interconnected die are fabricated, the wafer can be subject to warping, cracking, fracture, and so on. The wafer can be supported or stiffened. Further, connections between the wafer and elements such as power supplies, DC-to-DC converters, controllers, and so on can be accomplished by using a laser to reflow microbumps, C4s, ball grid arrays, and other soldered connections. Inter-die interconnect and redundancy to support back side power delivery for wafer-scale integration are enabled with laser-assisted bonding.

The FIG. 500 shows redundant die and inter-die interconnect. A wafer is shown 510. The wafer is populated with multiple die such as die 520. A number of the die shown can be redundant. Some of the redundant die will include defects, can be incomplete, can miss specifications, or can otherwise fail. The defects can be associated with the wafer on which the die are fabricated, associated with one or more processing steps for fabricating the die, and so on. This can result in die that are not operational, such as die 522. Recall that die can be fabricated on the wafer in order to ease some fabrication complexities, and that some of the added die can include partial die such as die 524. The failed die and the partial die can be excluded from a system formed by wafer-scale integration (WSI). In some cases, a die such as 524 can be partially functioning. The portion of the die that is functioning can be included in the WSI, while the portion of the die that is not functioning can be excluded. The functioning die can be inter-connected using inter-die interconnect 530. The inter-die interconnect can include multi-layer interconnect. The inter-die interconnect can be placed between the die associated with the multiple projects. Functioning die can be connected to the inter-die interconnect, while non-functioning die can be disconnected from the inter-die interconnect.

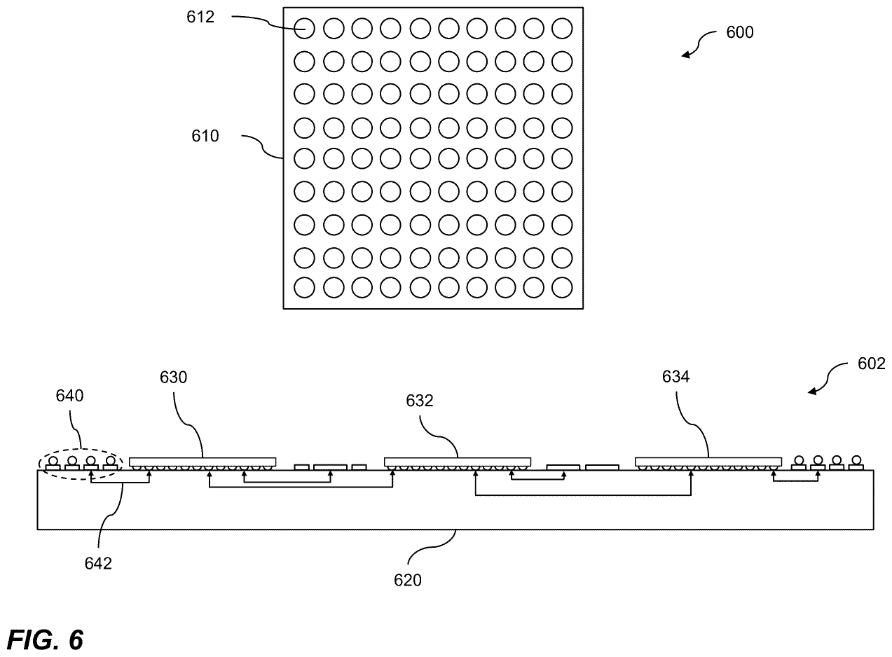

FIG. 6 illustrates a flip-chip and interposer with flip-chips for wafer-scale integration. One technique that can be used to approach the benefits of wafer-scale integration is to attach more than one chip or chiplet to a common substrate or interposer. The substrate can include a wafer, a carrier, a circuit board, and so on. To accomplish such a technique, all interconnections to a circuit or chiplet, including data connections, control and signal connections, power connections, and so on, can be made at the top layer of the chiplet. The connections at the top of the chiplet replace the traditional placement of pads at the periphery of the chiplet. To connect the top connections of the chiplet to the interposer, solder balls are placed on the top connections and the chiplet is inverted or “flipped.” The solder balls, when melted, can connect the top connections of the chiplet to corresponding connections or pads on the interposer. Further chiplets can be similarly flipped and connected to additional corresponding connections on the interposer. One challenge to the flip-chip technique is providing power to the chiplets. The power can be provided using back side power delivery for wafer-scale integration with modular power substrates (MPSs). The MPSs can be bonded to a back side of a wafer-scale integration interposer (WSII) via laser-assisted bonding (LAB). A further challenge to the flip-chip technique is that the aggregate weight of the flipped chiplets can be sufficient to pose a risk to the delicate wafer or interposer. The wafer can be stiffened or supported in order to protect it from the weight of the flipped chiplets. The stiffening can be accomplished using an isometric grid array (IGA) (discussed below).

The FIG. 600 includes an example flip-chip. Discussed previously, the flip-chip 610 differs from a traditional chip in that the connections to the flip-chip are made at the top of the chip rather than to pads located at the periphery of the chip. A top view of a flip-chip is shown. The top can include pads that can be connected to corresponding pads on a multi-chip module, a circuit board, an interposer, and so on. An example contact or pad 612 is shown. Multiple pads can be distributed across the top of the flip-chip. The pads can be oriented to correspond with receiving pads on the interposer. An array of pads is shown. In a usage example, a subset of pads can be required to connect the flip-chip to the interposer. Thus, required pads are present at the top of the flip-chip, while the unused pads can be omitted from the top of the flip-chip.

The illustration 602 shows an example interposer. As discussed previously, the interposer 620 can include a wafer, a carrier, a circuit board, and so on. One or more flip-chips can be attached to the interposer. In the figure, the flip-chips can include a first flip-chip 630, a second flip-chip 632, a third flip-chip 634, and so on. While three flip-chips are shown, other numbers of flip-chips can be attached to the interposer. In a usage example, the flip-chips can be attached to the interposer in a grid pattern. In addition to serving as a placement location for the flip-chips, the interposer can provide interconnect. The interconnect can be used to provide signals such as control signals, data, and so on to the flip-chips. The interconnect can further provide power to the flip-chips. Depending on the interposer used to receive the flip-chips, the interposer can include one or more layers of interconnect. The interconnect can include interconnect at a top surface of the interposer such as top surface interconnect 640. The interposer can further include additional layers of interconnect. The additional layers of interconnect can be fabricated on the interposer. The additional layers of interconnect can be isolated from each other using an insulating layer between the conducting interconnect layers. An example “lower layer” connection 642 is shown.

The use of flip-chips attached, bonded, coupled, etc. to an interposer can enable multichip module (MCM) techniques. A multichip module can refer to a substrate, carrier, circuit board, interposer, etc. onto which multiple ICs can be placed. The multiple ICs can be attached to the interposer, and the multiple ICs can be wired together using interconnect provided by the interposer. The interconnect associated with the interposer can provide power, control signals, and data between and among the ICs that are attached to the interposer. The power can be provided using modular power techniques. Depending on the particular type of MCM, the interposer can further include discrete components such as discrete resistors, discrete capacitors, discrete inductors, discrete diodes, etc. The interposer further includes wiring for interconnecting ICs and the discrete components, if any. The MCM can be packaged and used as if it were a single IC on a board such as a circuit board within a system. MCMs have also been referenced as heterogeneous integrated circuits and hybrid integrated circuits. A principal advantage of using MCMs is that multiple electronic components can be enclosed in a single “chip,” thereby improving modularity of a system design. Also, the use of MCMs can improve IC yields over ICs produced using monolithic IC design methodologies.

There can be several varieties of MCMs, where the MCM varieties are typically differentiated by size, complexity, design methodology, and so on. At one end of the complexity scale, an MCM can include standard off-the-shelf ICs. The ICs can be attached to a circuit board such as a printed circuit board and can be used in place of an existing chip or package of chips. The printed circuit board can be designed to match the size and pin-out of the existing chip or package of chips. An MCM can also be a complex element. The complex MCM can be based on one or more fully customized IC packages. The fully customized IC packages can be used to integrate multiple IC dies (e.g., unpackaged ICs) onto a substrate that provides interconnection among the dies. Because of the wiring requirements of the multiple IC dies, the substrate typically includes high density interconnection (HDI). The substrates that are used for the MCM can include thin films for interconnects (wires) and dielectrics (insulators), thick films that enable more than one layer of interconnect and ceramic, and substrates that include laminates based on organics or plastics. The MCM based on thin films of interconnects and dielectrics can result in the highest circuit densities.

The MCM design concepts described previously suggest promising leads for implementing wafer-scale integration ICs. Multiple circuit dies could be fabricated within the same wafer. The wafer could further include built-in self-test (BIST), circuit redundancy to provide spare parts, and “self-rerouting.” The self-rerouting can “reroute” around defective, incomplete, or failed elements and can wire in known good spare parts. In order to enable such capabilities, a significant number of interconnect layers would be required for WSI. Interconnect layer counts of approximately ten layers have been predicted. In order to implement WSI in a cost-effective manner, several techniques have been proposed, such as using an artificial neural network to develop a programmable topology, using a multichip-scale package, and so on.

Another technique that is being developed to enable wafer-scale integration is based on the use of a silicon interposer, as discussed above. The interposer can further include an interposer based on other materials such as glass. The silicon interposer, which can be a wafer, can be used to provide interconnections among a wide variety of components. The components include integrated circuits (chips), chiplets, power supplies, power converters, discrete electrical components, and so on. The interposer provides connection points that can be used to mechanically and electrically mount the chips, chiplets, etc. The interposer can be formed from inorganic materials such as glass or silicon, or organic materials such as those used to manufacture printed circuit boards. The electrical connections can be set to a pitch to simplify the attaching of the electrical elements. The electrical connections can be based on standardized manufacturing techniques such as using solder balls, micro-bumps, controlled collapse chip connection (C4) bumps, and/or electroplated bumps. The bumps on a chip are produced on the “top” side of a wafer (e.g., the non-substrate side) as a final processing step for the wafer. To mount the chips to the interposer, the chips are “flipped” using a flip-chip technique. The bumps at the top of the chips connect to pads on the interposer. The interposer can enable connections from the flip-chip to a standard connection arrangement such as a grid. The interposer can further provide one or more layers of interconnect according to the process used to manufacture the wafer. Thus, higher densities, higher bandwidth, and faster speeds can be achieved. The layers of interconnect are used to provide power and ground, control signals and data, and so on.

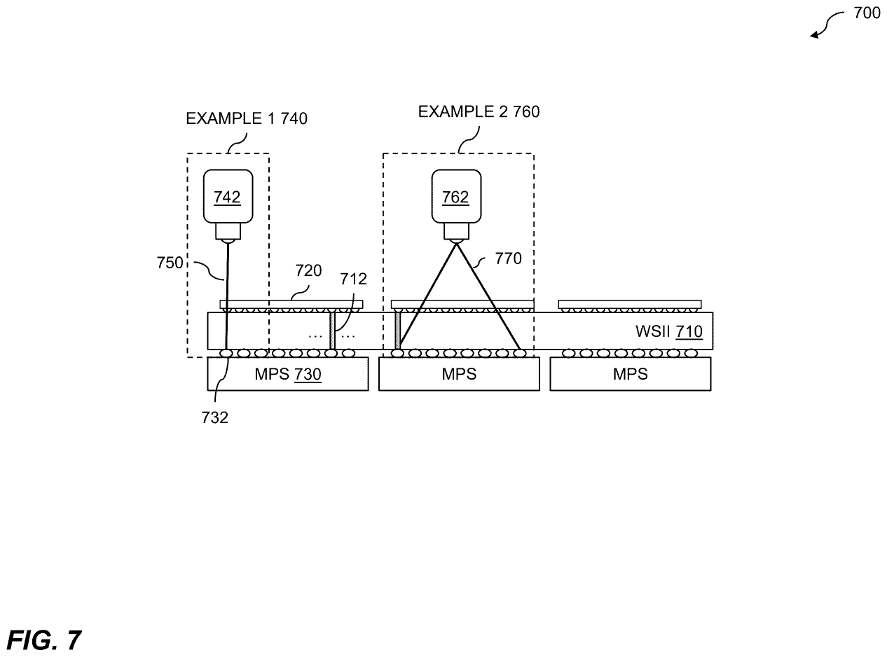

FIG. 7 is an example of laser-assisted bonding. Discussed previously and throughout, laser-assisted bonding can be used to bond elements such as modular power substrates (MPSs) to a back side of a wafer-scale integration interposer (WSII). Compared to reflow soldering techniques, which are generally designed to reflow a majority of solder connections for electronic elements such as chiplets, the laser-assisted bonding can offer precise, localized heating of materials such as solder bumps. Thus, bonding of elements such as the plurality of MPSs can be accomplished while minimizing thermal stress of a WSII, components fabricated on or mounted to the WSII, and so on. Laser-assisted bonding can further enable faster process times since only the contacts such as solder bumps, C4s, and so on, are heated. Also, laser-assisted bonding can enable uniform heating of contacts and can prevent overheating of the WSII, heat sensitive elements, etc. The wafer-assisted bonding enables back side power delivery for wafer-scaled integration.

A wafer-scale integration interposer (WSII) is accessed. A front side of the WSII is bonded to a plurality of chiplets. The WSII includes a plurality of through-silicon vias (TSVs). A plurality of modular power substrates (MPSs) is bonded to a back side of the WSII. The bonding is accomplished via laser-assisted bonding (LAB). The plurality of MPSs is coupled electrically to a plurality of DC-to-DC power converters. DC power is sent by the plurality of DC-to-DC power converters, to the plurality of chiplets. The sending is based on the plurality of MPSs and the plurality of TSVs.

The example 700 includes a wafer-scale integration interposer (WSII) 710. The WSII can include an inorganic wafer such as a silicon wafer, a glass wafer, and so on. The WSII can include an organic wafer. The WSII includes a plurality of through-silicon vias (TSVs) 712. A TSV can include an electrical connection that completely passes through a die or wafer such as a silicon wafer. The plurality of TSVs is oriented vertically in order to enable connections between the front side of the wafer and the back side of the wafer. A front side of the WSII is bonded to a plurality of chiplets 720. The plurality of chiplets can include processor chiplets, multiprocessor chiplets, graphics processor chiplets, memory chiplets, switching chiplets, application-specific integrated circuits (ASICS), systems-on-chip (SoCs), memory chiplets, artificial intelligence (AI) accelerators, machine learning (ML) accelerators, and so on. The plurality of chiplets can include optical chips such as VCSELs. Noted previously and throughout, the plurality of chiplets can create prodigious heat during operation of the chiplets and other electrical and electronic elements. The heat can result from current provided to the chiplets such as active current, overcurrent, leakage current, and so on. The heat can result from IR drops associated with interconnect, active devices, leakage current, etc. within the chiplets. The chiplets can be bonded to the WSII via micro-bumps, controlled collapse chip connections (C4s ), and so on.

The example 700 includes a plurality of modular power substrates (MPSs) 730. The plurality of MPSs can be bonded to a back side of the WSII. The bonding of each MPS within the plurality of MPSs can align with contacts, pins, interconnect, etc. associated with the back side of the WSII. The bonding the MPSs to the WSII can include bonding to one or more TSVs. The bonding is accomplished via laser-assisted bonding (LAB). The MPSs can include one or more DC-to-DC converters, a high voltage socket, a high voltage connector, and so on. In embodiments, each MPS within the plurality of MPSs is based on a form factor mirroring one or more corresponding chiplets within the plurality of chiplets on the front side of the WSII. In embodiments, the LAB can include reflowing, by a laser, one or more solder balls, wherein the bonding is based on the one or more solder balls that were reflowed. The solder balls can include microbumps. In embodiments, the one or more solder balls comprise controlled collapse chip connections (C4s). Example solder balls are shown 732. The solder balls can be arranged in a pattern such as a ball grid array (BGA).

In the FIG. 700, two example laser assisted examples are shown. In example 1 740, a laser 742 is shown to project 750 through a front side of the WSII 710 onto a single solder ball. The single solder ball can include a microbump, a C4, a solder ball within a ball grid array, and so on. The laser can include a variety of lasers such as a diode laser, a blue laser, and the like. The laser can provide localized, controlled heating of the solder ball resulting in reflow of the solder ball. The reflow of the solder ball can bond the MPS to the WSII. In example 2 760, a laser 762 is shown to project 770 onto a plurality of solder balls. The plurality of solder balls can include solder balls within a BGA. The laser in example 2 can reflow a plurality of solder balls within the BGA substantially simultaneously. The reflowing by the laser in example 2 can be accomplished by directing the laser to a plurality of solder balls, but stepping from solder ball to solder ball, etc.

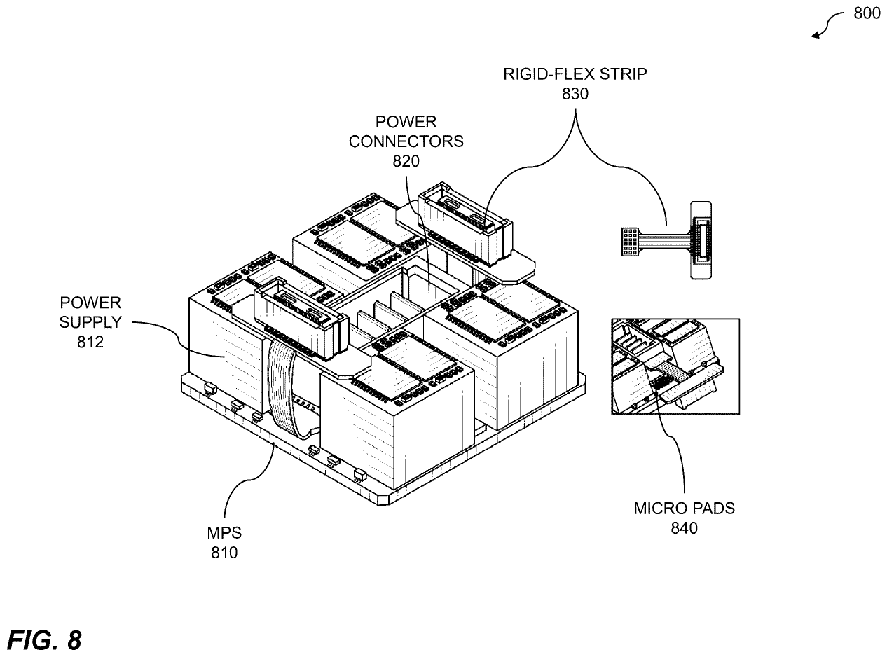

FIG. 8 is a diagram of a modular power substrate (MPS). Chiplets, including integrated circuits such as processor circuits, require power in order to operate. When a significant number of circuits or chiplets is obtained to achieve an objective such as a processing objective, the power requirements for the many chiplets become substantial, and the requirements for providing the power become more stringent. The power requirements can become more stringent because the aggregate power delivery to the chiplets can include tens, hundreds, or more amperes. Further, the many circuits to which the power is provided can generate copious heat (e.g., thermal dissipation). The heat generated by the various elements of a system such as power supplies, chiplets, and so on causes the elements to expand. Since the elements comprise different materials, coefficients of expansion of the elements can differ. To counter the potentially disastrous effects such as fracture resulting from differing coefficients of expansion (COEs), power supplies that can be used to power one or more chiplets can be arranged on one or more modular power substrates (MPSs). The MPSs can enable lateral displacement between other elements that expand and contract, minimizing potential material strain. The MPSs are bonded to the WSII via laser-assisted bonding (LAB). The MPSs enable back side power delivery for wafer-scale integration with laser-assisted bonding.

A wafer-scale integration interposer (WSII) is accessed. A front side of the WSII is bonded to a plurality of chiplets. The WSII includes a plurality of through-silicon vias (TSVs). A plurality of modular power substrates (MPSs) is bonded to a back side of the WSII. The bonding is accomplished via laser-assisted bonding (LAB). The plurality of MPSs is coupled electrically to a plurality of DC-to-DC power converters. The plurality of DC-to-DC power converters send DC power to the plurality of chiplets. The sending is based on the plurality of MPSs and the plurality of TSVs.

The diagram 800 shows a modular power substrate (MPS). Elements such as one or more power supplies, connectors, rigid-flex strips, etc. can be mounted, coupled, etc. to an MPS 810. The number of elements that can be coupled to the MPS can be based on the size, shape, and so on of the MPS. A plurality of MPSs can be used to deliver power to a plurality of chiplets. The MPSs can be based on a variety of substrate materials. In a usage example, one or more MPSs within the plurality of MPSs can include an organic substrate. An organic substrate can be based on one or more organic materials such as organic materials used to manufacture printed circuit boards. The organic substrate materials can include paper cores impregnated with phenolic resin; woven or unwoven grass cloth impregnated with epoxy or cyanate ester among others; natural fibers; etc. In a further usage example, one or more MPSs within the plurality of MPSs can include an inorganic substrate. An inorganic substrate can be based on a silicon glass with a coefficient of expansion similar to the WSII, etc.

An MPS can include a form factor. Recall that a plurality of chiplets can be bonded to a front side of a wafer-scale integration interposer (WSII). A plurality of MPSs can be based on a form factor mirroring one or more corresponding chiplets, within the plurality of chiplets, on the front side of the WSII. The plurality of MPSs is coupled to the plurality of chiplets. The MPSs can be electrically coupled to a unified control board (UCB) and can also be bonded to a back side of the WSII. The bonding of the MPSs to the WSII is accomplished via laser-assisted bonding (LAB). Thus, the MPSs can be situated between the UCB and the WSII. As described above, the WSII and the UCB can have different coefficients of thermal expansion leading to different lateral movements. These lateral movements can be sufficient to crack connections and/or introduce warpage into components which can lead to connection failures such as disconnected connectors, cracked C4s, damage due to physical strain, etc. The modularity of the MPSs can provide a flexible power delivery system to the chiplets which can accommodate different movements of the WSII and UCB due to thermal expansion. For example, an MPS at one side of the WSII can be decoupled from an MPS on the other side of the WSII, thus accommodating various movements across the WSII and UCB.

A power supply 812 can be coupled to the MPS. In the figure, three additional power supplies are shown coupled to the MPS. The number of power supplies coupled to the MPS can be based on the dimensions of the MPS, the dimensions of the power supplies, a voltage or current required by the chiplets, coefficients of expansion, heat dissipation, etc. The power supplies can be stacked. The MPS can include one or more power connectors 820. The power connectors can fit with a high voltage socket, a high-power socket, etc. from the UCB. The power connectors can include one or more of positive terminals, negative terminals, common terminals, and so on. The high voltage socket can accommodate lateral movement due to thermal expansion. The MPS can include one or more rigid-flex strips 830. The one or more rigid-flex strips can be used to connect an MPS to the UCB. The connection can include control signals, power delivery, and so on. The rigid-flex strips can provide further protection from differing rates of thermal expansion between the WSII and the UCB, through the use of a flexible connector. The rigid flex strips can carry control information from the UCB to the MPS and can control the flow of DC power to the chiplets. The MPS can include one or more micro pads 840. The micro pads can include a ball grid array (BGA). The micro pads can enable bonding of the MPS to the WSII. The bonding can be accomplished using laser-assisted bonding. A laser can be used to reflow a single C4 connection, an entire BGA, and so on.

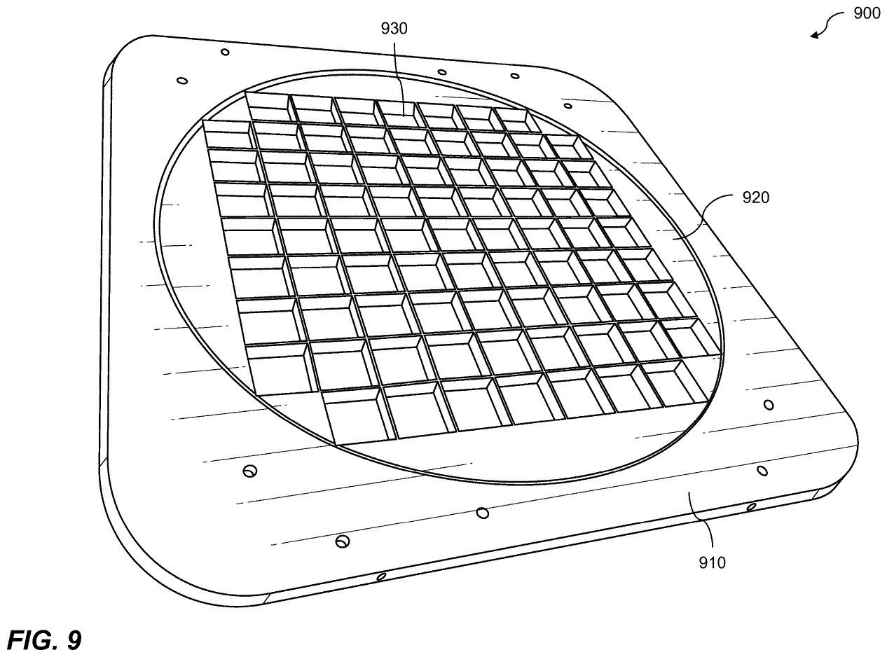

FIG. 9 is a diagram of an isometric grid array. An isometric grid array (IGA) can include reinforcement structures. The IGA can provide stiffening to a wafer-scale integration interposer (WSII). The WSII can include a plurality of chiplets that can be bonded to a front side of the WSII. A plurality of modular power substrates (MPSs) can be coupled to a back side of the WSII. The attaching the MPSs to the back side of the WSII is accomplished through a plurality of open recesses within the IGA. The walls of the open recesses within the MPSs can be sufficiently thin to minimize consumption of WSII real estate by the IGA. The walls of the IGA can further be strong enough to support and stiffen the WSII, thereby substantially reducing the risk of fracturing the WSII. The fracturing of the WSII can result from the thinness to which the WSII was ground, polished, and so on in order to enhance fabrication of through-silicon vias (TSVs) associated with the WSII. The fracturing can also result from the weight of the chiplets and other elements such as controllers, switches, and the MPSs. The MPSs can be bonded to a backside of the WSII via laser-assisted bonding (LAB). The TSVs enable communication between the chiplets and the MPSs. The stiffening isometric grid array enables back side power delivery for wafer-scale integration with laser assisted bonding.

The diagram 900 shows an isometric grid array (IGA) 910. The IGA can include a variety of materials such as various alloys of steel, aluminum, and so on. In a usage example, the IGA can comprise copper. The IGA can include a recess such as a circular recess 920. The recess 920 can include a variety of sizes, where the sizes can correspond to a size of a wafer. The wafer can include a 300 mm wafer, a 200 mm wafer, and the like. The recess can accommodate the WSII. The IGA can further include open recesses such as open recess 930. The further open recesses can enable attaching a plurality of modular power substrates (MPSs) to the back side of the WSII. The sizes of the open recesses can be chosen to accommodate the MPSs and/or a lateral displacement of the MPSs that can result from heating of the MPSs during operation. In embodiments, the IGA comprises a grid. The IGA grid can include square open recesses as shown, or further shapes appropriate to a form factor of the MPSs. The further shapes can include rectangles, circles, ovals, a honeycomb, etc.

Recall that the MPSs can be based on a form factor. In embodiments, each MPS within the plurality of MPSs is based on a form factor mirroring one or more corresponding chiplets, within the plurality of chiplets, on the front side of the WSII. The form factor associated with the MPSs can also be applied to the IGA. In embodiments, each open recess within the plurality of open recesses within the IGA matches a form factor of a corresponding MPS in the plurality of MPSs. Recall that the MPSs are coupled to the back side of the WSII through the plurality of open recesses within the IGA. In embodiments, the IGA contacts the back side of the WSII between each MPS in the plurality of MPSs. Embodiments include inserting each MPS within the plurality of MPSs that was bonded into an isometric grid array (IGA), wherein the IGA includes a plurality of open recesses. The back of the MPSs can then be bonded to the back side of the WSII via laser-assisted bonding. The MPSs can be bonded before being inserted, as a group, into the IGA. If fewer than a full complement of MPSs have been inserted to the back side of the WSII, then one or more of the open recesses within the IGA can remain open. The IGA can stiffen the WSII as discussed and can provide other benefits to the WSII. In embodiments, the IGA maintains a coplanarity of the WSII. The coplanarity of the WSII can counteract sagging or warping of the WSII due to the weight of bonded and attached elements, and any thermal expansion of elements such as chiplets and MPSs that are bonded to or attached to the WSII.

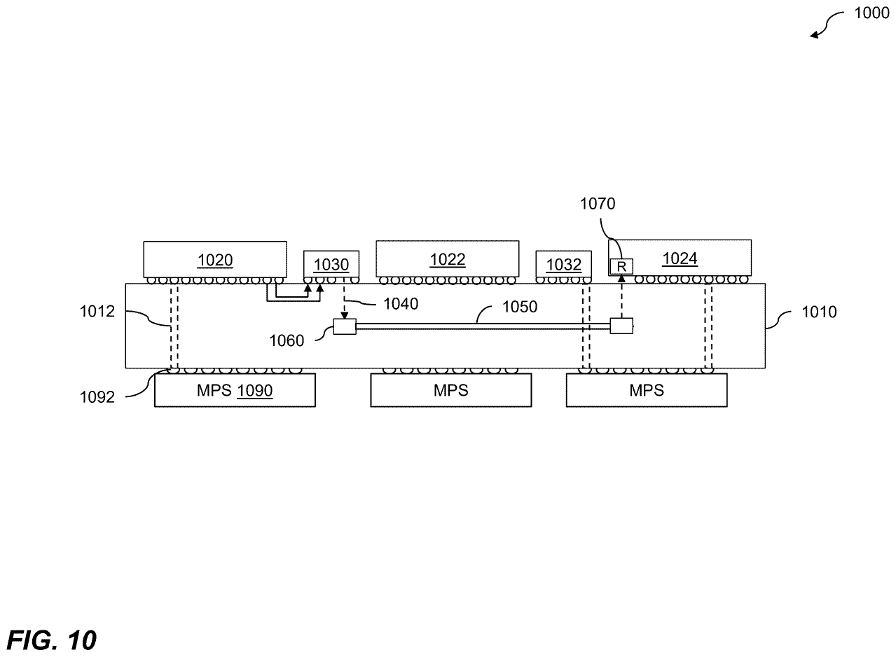

FIG. 10 illustrates a cross-section for a photonic wafer-scale interposer (PWSI) with chiplets. In order to improve interconnection between and among chiplets such as switching chiplets, AI chiplets, and so on bonded to a front side of a wafer-scale integration interposer (WSII), the WSII can include photonic elements. In embodiments, the WSII comprises a photonic wafer-scale interposer (PWSI), wherein the PWSI includes a plurality of waveguides, wherein a first chiplet within the plurality of chiplets is coupled with a second chiplet within the plurality of chiplets based on a first waveguide within the plurality of waveguides. The PWSI can include electronic elements, photonic elements, and so on. The PWSI can include a plurality of waveguides, where the waveguides can be used to transfer data as optical signals. Recall that laser-assisted bonding (LAB) is used to support back side power delivery for wafer-scale integration. The LAB is used to reflow solder bumps, C4s, microbumps, bump grid arrays, and so on. One advantage of laser-assisted bonding is that solder bumps such as C4s can be reflowed without introducing stresses into the wafer. The stresses can be introduced into a wafer when the wafer is heated for a reflow process step.

The photonic wafer-scale interposer (PWSI) 1010 can include a plurality of waveguides. A front side of the PWSI is bonded to a plurality of chiplets. The chiplets can be connected, attached, or otherwise coupled to the PWSI 1010. At least two chiplets, such as chiplet 1020, chiplet 1022, and chiplet 1024, are bonded to the front side of the PWSI. The chiplets can be bonded to the PWSI via micro-bumps, controlled collapse chip connections (C4s), and so on. The bonding can be accomplished via laser-assisted bonding or another bonding method, such as a flip-chip application. The PWSI can include a plurality of through-silicon vias (TSVs) such as TSV 1012. A TSV can include an electrical connection that completely passes through a wafer such as a silicon wafer, a glass wafer, or a die. The plurality of TSVs can be oriented vertically in order to enable connections between the front side of the wafer and the back side of the wafer. A chiplet can be coupled to a light source, where the light source can include a surface-emitting light source. The PWSI can include one or more surface-emitting light sources such as surface-emitting light source 1030 and surface-emitting light source 1032. Data is sent by a first chiplet to a second chiplet. The sending is based on a first waveguide such as waveguide 1050 within the plurality of waveguides. The waveguide can include one or more confinement regions. The waveguide can include a transition between confinement regions associated with the waveguide. A transition can be made between at least one low confinement region and at least one high confinement region. The transition can include the first waveguide. The second chiplet, such as chiplet 1024, receives the data that was sent.

A data request can include sending data from a first chiplet to a second chiplet.

The data request can be converted from electrical data, which can be serialized electrical data, to optical data, and reconverting the optical data to electrical data. In a usage example, the sending includes transmitting the data, by the first chiplet, to a first surface-emitting light source within one or more surface-emitting light sources. The electrical data can be converted to optical data using the surface-emitting light source such as surface-emitting light source 1030. The surface-emitting light source can include a light source within a plurality of light sources. The PWSI can include one or more surface-emitting light sources. The surface-emitting light sources can be based on one or more varieties of light sources. The one or more surface-emitting light sources can include a vertical-cavity surface-emitting laser (VCSEL). Other types of light sources can also be used. In other embodiments, the one or more surface-emitting light sources can include a light emitting diode (LED).

In order to provide light from a surface-emitting light source to a waveguide, the light is conveyed to an optical coupler. Optical information is conveyed 1040, by the first surface-emitting light source 1030, to a first optical coupler 1060. The first optical coupler couples the optical information to the first waveguide 1050. The optical information is based on the data. The first coupler can be based on one or more coupling techniques. In embodiments, the first optical coupler can include a grating coupler. The grating coupler can diffract light at specific frequencies, thereby providing efficient transfer of light at a specific frequency into or out of a waveguide such as a waveguide within the PWSI. In embodiments, the first optical coupler comprises an off-axis diffractive lens. An off-axis diffractive lens can direct light at an angle with respect to the optical axis of the lens. The first optical coupler can include a mirror. The mirror can be used to redirect light from the surface-emitting light source into the waveguide. The first optical coupler can include a bent waveguide. The bent waveguide can include a high containment region of a waveguide. The high containment waveguide can redirect the light while minimizing loss of light in the region of the bend of the waveguide.

The second chiplet 1024 can receive the data that was sent. The receiving can include coupling the optical information, using a second optical coupler, from the first waveguide to an optical receiver. The second optical coupler can be based on one or more receiving techniques. The second optical coupler can include a grating coupler. The second grating coupler can diffract light at specific frequencies to enable efficient transfer of light out of a waveguide within the PWSI. The second optical coupler can include a photodiode. The photodiode can convert the optical data to digital data. The data received at the optical coupler can be transferred. The data can be transferred by the optical receiver to the second chiplet. The data that is transferred can be transferred as optical data or transferred as digital data. The data can be received at the second chiplet by a receiver 1070. If the receiver receives optical data, the receiver can convert the optical data to digital data. If the receiver receives digital data, the digital data can be used as received, converted from serial data to parallel data, and so on.

Recall that a plurality of modular power substrates (MPSs) is bonded to a back side of the PWSI. In the FIG. 1000, the plurality of MPSs can include MPS 1090. The MPSs are coupled electrically to a plurality of DC-to-DC converters (not shown in cross-section 1000). The MPSs can be bonded to a back side of the PWSI via a laser-assisted bonding (LAB) technique. The LAB can create localized heat at points on the PWSI where the MPSs are bonded to the PWSI. The bonding can be accomplished using solder balls 1092 such as microbumps, controlled collapse chip connections (C4s), ball grid arrays (BGAs), and so on. The bonding of the MPSs to the PWSI can include bonding the MPSs to one or more through-silicon vias (TSVs) such as TSV 1012. The laser-assisted bonding is able to create heat at the solder balls without heating the PWSI using a reflow soldering technique. Heating the PWSI using a reflow technique can cause previously soldered connections to reflow and potentially disconnect or short, damage diffusions, damage waveguides, and so on. The MPSs can send power to the chiplets. Embodiments include sending DC power, by the plurality of DC-to-DC power converters, to the plurality of chiplets, wherein the sending is based on the plurality of MPSs and the plurality of TSVs.

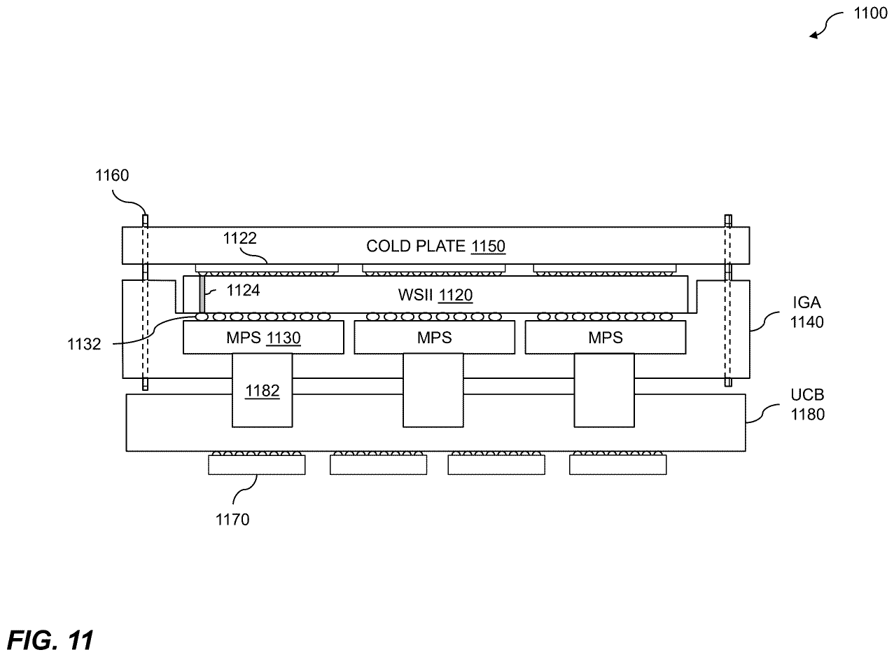

FIG. 11 is a cross-section of an apparatus for back side power delivery for wafer-scale integration with laser-assisted bonding. Power such as DC power from DC-to-DC power converters within a plurality of DC-to-DC power converters can be provided to one or more chiplets bonded to a wafer-scale integration interposer (WSII). In embodiments, the plurality of DC-to-DC power converters comprises a unified circuit board (UCB), wherein the UCB is coupled electrically to the plurality of MPSs by a plurality of high-power sockets. The high-power sockets can enable DC power to be sent by the universal control board (UCB) to a plurality of chiplets. The sending can be accomplished using a plurality of DC-to-DC converters, a plurality of modular power substrates (MPSs), and a plurality of through-silicon vias (TSVs). The plurality of chiplets can be bonded to a front side of a wafer-scale integration interposer (WSII). The plurality of MPSs can be bonded to a backside of the WSII, where the bonding the MPSs is accomplished via laser-assisted bonding (LAB). The MPSs can be coupled to the UCB based on a plurality of high-power sockets. The UCB can further include a plurality of DC-to-DC power converters. The WSII can be stabilized. The stabilizing the WSII can be accomplished by an isometric grid array (IGA). The IGA supports the WSII, stabilizes the WSII, etc. The supporting the WSII can reduce the risk of fracturing the WSII due to heating of the WSII during operation, stresses introduced to the WSII from the weight of the elements bonded to the WSII, and so on. Embodiments include an isometric grid array (IGA), wherein the IGA comprises a grid, wherein each MPS within the plurality of MPSs that was bonded is inserted into the IGA, and wherein the IGA maintains a coplanarity of the WSII. The coplanarity of the WSII can further reduce the risk of fracturing the WSII.

The through-silicon vias (TSVs) can be used to provide connections between a front side of the WSII and a back side of the WSII. The WSII can be used to achieve wafer-scale integration (WSI). The WSII can be used to mount various elements such as electrical elements and to provide interconnections among the mounted elements. The interposer can include inorganic materials such as silicon, glass, and so on. An apparatus for power delivery is disclosed comprising: a wafer-scale integration interposer (WSII), wherein a front side of the WSII is bonded to a plurality of chiplets, wherein the WSII includes a plurality of through-silicon vias (TSVs); a plurality of modular power substrates (MPSs), wherein the plurality of MPSs is bonded to a back side of the WSII, wherein the bonding is accomplished via laser-assisted bonding (LAB); and a plurality of DC-to-DC power converters, wherein the plurality of DC-to-DC power converters are coupled electrically to the plurality of MPSs, and wherein the plurality of DC-to-DC power converters sends power to the plurality of chiplets bonded to the WSII based on the plurality of MPSs and the plurality of TSVs.

The apparatus 1100 includes a wafer-scale integration interposer (WSII) 1120, wherein a front side of the WSII is bonded to a plurality of chiplets, wherein the WSII includes a plurality of through-silicon vias (TSVs). The WSII can include inorganic materials or organic materials. In a usage example, the interposer can include a silicon interposer or a glass interposer. In embodiments, the WSII comprises a photonic wafer-scale interposer (PWSI), wherein the PWSI includes a plurality of waveguides within the PWSI. The PWSI can be used to send signals as optical signals via the waveguides. In a usage example, digital signals such as serial digital signals are converted to optical signals and transferred, via a waveguide within the PWSI, between chiplets bonded to the PWSI. The PWSI can be used to form a network such as an optical network. In embodiments, the PWSI comprises an optical wafer-scale network switch, wherein one or more chiplets in the plurality of chiplets comprise one or more switching chiplets, respectively. The optical wafer-scale network can be used for applications requiring high bandwidth such as high memory bandwidth. In embodiments, the PWSI comprises an optical wafer-scale AI accelerator, wherein one or more chiplets in the plurality of chiplets comprises one or more artificial intelligence (AI) accelerators.

Micro-bumps discussed above can be used to mount the one or more chiplets to the front side of the WSII. Communications between the chiplets can be accomplished within metal layers of the interposer, thereby reducing latency and parasitics such as resistance, capacitance, and inductance, enabling improvement of signal integrity and/or bandwidth, etc. The reductions and improvements result from the opportunity for many more wires to be established within the WSII compared to what would have been possible with a typical packaging interface. Thus, the WSII can enable extremely high bandwidth buses and control signals between chiplets mounted to the WSII. The WSII can include one or more optical waveguides. The optical waveguides can enable chip-to-chip communications via one or more wavelengths of light. The optical waveguides can comprise the buses and control signals between chips. The wafer interposer can also be used to attach additional boards, modules, components and so on. The further attachments can be located on the opposite side of the wafer interposer from the mounted chiplets.

The apparatus 1100 includes a plurality of chiplets, such as chiplet 1122. The chiplets can include one or more processor chiplets, multi-core processor chiplets, graphics processor chiplets, systems-on-a-chip, memory chiplets, application-specific integrated circuits (ASICs), artificial intelligence (AI) or machine learning (ML) accelerators, I/O chips, vertical-cavity surface-emitting lasers (VCSELs), light emitting diodes (LEDs), and so on. The chiplets can include an integrated circuit designed for a flip-chip application. A chiplet design for a flip-chip application can include a chiplet for which connections to the chiplet are accomplished at the top layer of the chiplet rather than at the periphery of the chiplet. The connections can include positive and negative DC power connections, data connections, control connections, and so on. The various chiplet connections can include pads on the top layer of the chiplets. The chiplets can include a chiplet that can accomplish a processing function such as a deep learning function.

Various techniques can be used to make connections to the top of a chiplet. In a usage example, a technique based on micro-bumps can be used. A micro-bump can be associated with each connection point or pad on each chiplet. The micro-bumps can comprise a dense array of connection points or pads. The micro-bumps can include a material appropriate for mounting the chiplet to a substrate, a board, an interposer, and so on. The micro-bumps can include solder micro-bumps. These micro-bumps can be arranged in a ball grid array (BGA) or some other geometry. The WSII includes a plurality of through-silicon vias (TSVs) such as shown at 1124. The TSVs can provide a connection between the micro-bumps on the top side of the WSII and the connectors on the bottom side of the WSII. The TSV connections can be used to deliver power to the chiplets through the back side of the WSII.

The apparatus 1100 includes a plurality of modular power substrates (MPSs) 1130, wherein the plurality of MPSs is bonded to a back side of the WSII, wherein the bonding is accomplished via laser-assisted bonding (LAB). The bonding the plurality of MPSs to the WSII can be accomplished using one or more bonding techniques. The bonding can be accomplished using solder balls. The solder balls can be arranged in a grid such as a ball grid array. In embodiments, the one or more solder balls comprise controlled collapse chip connections (C4s). The soldering using the solder balls can be accomplished by reflowing the solder balls. In embodiments, the reflowing comprises shining the laser through a front side of the WSII. The laser can generate heat at the solder balls thereby causing the solder balls to reflow. In embodiments, the reflowing can include shining the laser through a front side of the WSII.

An MPS can be coupled to one or more elements associated with the WSII. In embodiments, each MPS in the plurality of MPSs is coupled to one or more chiplets within the plurality of chiplets. In embodiments, the bonding includes coupling each MPS within the plurality of MPSs to one or more chiplets within the plurality of chiplets, wherein the coupling includes one or more TSVs within the plurality of TSVs. The MPSs can provide DC power to the one or more chiplets to which the MPSs are coupled. In embodiments, each MPS within the plurality of MPSs is based on a form factor mirroring one or more corresponding chiplets within the plurality of chiplets. The chiplets are bonded to the front side of the WSII. The form factor of the MPS can be associated with or dependent on components mounted to the wafer-scale integration interposer. In a usage example, the plurality of MPSs can be based on a form factor mirroring the corresponding chiplets. The form factor of the MPS can have a 1:1 relationship to the one or more corresponding chiplets or can include other shape factors. The MPSs can be based on a variety of materials. In a usage example, one or more MPSs within the plurality of MPSs comprise an inorganic substrate. An inorganic substrate can include a silicon substrate, a glass substrate, and so on. In another usage example, one or more MPSs within the plurality of MPSs comprise an organic substrate. The organic substrates can include substrates such as printed circuit boards. Recall that the chiplets are bonded to the front or top side of the WSII. The plurality of MPSs is coupled to a back side of the WSII. Connections between the wafer interposer and the MPS can be accomplished using the solder balls 1132. Noted above, the solder balls can include C4s.

An MPS 1130 can include a plurality of step-down power modules and/or DC-to-DC converters. The DC-to-DC converters on an MPS can be placed across the MPS. The DC-to-DC converters on the MPSs can accomplish altering of a DC voltage. The altering the DC voltage can result in a second DC voltage. In a usage example, the power can be altered, wherein altering, by the plurality of MPSs, is accomplished by the DC power that was sent, and wherein the altering is based on a second voltage conversion. The second voltage conversion can include a second DC-to-DC voltage conversion. In embodiments, the second voltage conversion results in a voltage less than a threshold. The threshold can include a voltage appropriate to a voltage required by a functional chip. In embodiments, the threshold can include 1 volt. The MPS can be stiffened for a variety of purposes, such as to maintain planarity. The stiffening can be accomplished by a stiffening ring (not shown).

In embodiments, the apparatus 1100 includes an isometric grid array (IGA) 1140, wherein the IGA comprises a grid, wherein each MPS within the plurality of MPSs that was bonded is inserted into the IGA, and wherein the IGA maintains a coplanarity of the WSII. The IGA can stiffen the WSII. The stiffening the WSII can provide support to the WSII to prevent fracturing the WSII. In other embodiments, the IGA maintains a coplanarity of the WSII.

In embodiments, the apparatus 1100 includes a cold plate 1150. The IGA can be mounted to a cold plate, wherein the cold plate contacts the plurality of chiplets bonded to a front side of a WSII. The cold plate can be used to extract a portion of heat generated by the plurality of chiplets as the plurality of chiplets operates. Recall that prodigious amounts of heat can be generated by chiplets and other electronic elements as they are operating. This point can be particularly relevant to high-performance chiplets. The cold plate can be attached to the plurality of chiplets to cool the chiplets. The attaching can include a thermal interface material (TIM). The cold plate can include a plurality of plates such as an inlet plate, a jet-plate, and a fin-plate. Coolant at a first temperature can be sent into at least one inlet nozzle located on the inlet plate. The sending can include spraying the coolant, by the jet-plate, on the fin-plate. At least a portion of the heat that was created by the chiplets and other electronic elements can be transferred, by the cold plate, to the coolant that was sent. The coolant can be captured, at a second temperature, from one or more outlet chambers within the jet-plate. The coolant can be cooled from the second temperature to the first temperature and recirculated for continued cooling of the chiplets. The WSII can be held between the IGA and the cold plate by fastening the cold plate to the IGA. Alternatively, the fastening can be between the cold plate and a UCB (explained below). The fastening can be accomplished based on one or more clamps, spring-loaded fasteners, screws, bolts, and so on. A plurality of fastening techniques can be used such as using both spring-loaded fasteners and clamps. In embodiments, the mounting is based on one or more spring-loaded fasteners 1160. Any other fasteners, such as a screw, clamp, and so on, can be used. The spring-loaded fasteners can squeeze the WSII between the cold plate and the IGA. In embodiments, the mounting is based on the one or more spring-loaded fasteners. In other embodiments, the mounting is based on one or more clamps.

The apparatus 1100 includes a plurality of DC-to-DC power converters 1170, wherein the plurality of DC-to-DC power converters are coupled electrically to the plurality of MPSs, and wherein the plurality of DC-to-DC power converters sends power to the plurality of chiplets bonded to the WSII based on the plurality of MPSs and the plurality of TSVs. As described above, each DC-to-DC power converter in the plurality of DC-to-DC power converters can be coupled to a respective MPS in the plurality of MPSs. The coupling between each DC-to-DC converter and a respective MPS can enable power transfer, control, and so on and can remain reliable when the DC-to-DC converters and the MPSs are operating. The mechanical connection can accommodate a maximum lateral displacement of the UCB due to thermal expansion during operation. The handling a maximum lateral displacement is critical to maintaining reliable mechanical connections between and among components, the WSII, one or more UCBs, one or more MPSs, and so on.

In embodiments, the plurality of DC-to-DC power converters comprises a unified circuit board (UCB), wherein the UCB 1180 is coupled electrically to the plurality of MPSs by a plurality of high power sockets. An MPS can include a connector, where the connector can be used to couple the MPS to the UCB. For the apparatus 1100, the connector can comprise a socket 1182 on the UCB. The socket can comprise a high-power socket, a high voltage socket, and so on. The coupling can include one or more plugs, pins, terminals, contacts, etc. from the UCB which can be inserted into the socket. In a usage example, the mechanical connection can be based on a high voltage socket, wherein the high voltage socket transfers power from the UCB to the plurality of MPSs. The high voltage socket can be used to provide a first DC voltage that can be converted to a second DC voltage by one or more DC-to-DC converters. The coupling can accommodate a maximum lateral displacement of the UCB due to thermal expansion during operation. In a usage example, the coupling can include a compliant connector. The lateral displacement can result from thermal expansion of the WSII, the UCB, and/or the MPS during operation.

The UCB 1180 can include a digital controller chip (not shown). The DC-to-DC converters can be controlled by a control chip associated with the UCB. The digital controller chip can control power delivery to the plurality of chiplets. The controlling power delivery can include enabling or disabling power transfer, controlling an input voltage to and an output voltage from a DC-to-DC converter, and the like. Control signals can be sent between the UCB and the MPSs via the connector, or by one or more rigid flex strips previously described. The control signals can enable and disable elements such as controller chips and DC-to-DC converters, can provide instructions to controller chips, etc.

As explained above and throughout, the WSII and the UCB can expand at different rates due to different CTEs. Thus, the MPSs that are coupled to the UCB can also move, which can cause connections between the WSII and the MPSs to become unreliable. To mitigate this movement due to expansion, as explained previously, the MPS can be designed modularly, effectively isolating movement between MPSs. In addition, the socket, which can be a high-power socket, a high voltage socket, etc., can comprise a compliant connector.

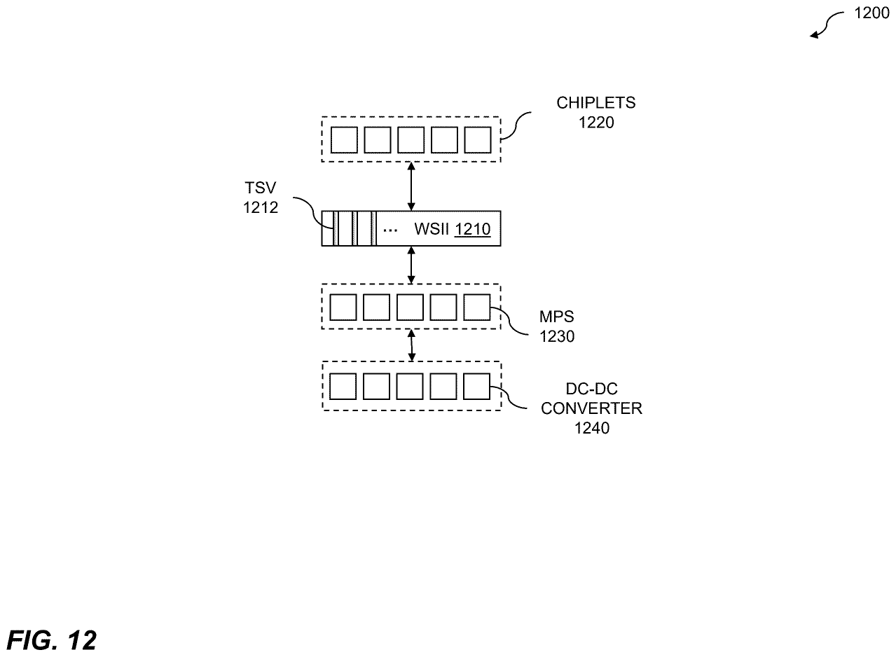

FIG. 12 is a system diagram for back side power delivery for wafer-scale integration with laser-assisted bonding. Power can be provided to the WSII by a unified control board. Recall that the WSII can be bonded to a plurality of chiplets. The chiplets can include processors, multiprocessors, machine learning (ML) processors, AI accelerators, graphics processors, I/O chips, memories, switches, and so on. The chiplets can be bonded to a front side of the WSII. The chiplets can be in communication with elements such as modular power substrates (MPSs) that can be bonded to a back side of the WSII. The bonding the MPSs to a back side of the WSII can be accomplished via laser-assisted bonding (LAB). The communication between the chiplets and the MPSs can be accomplished using through-silicon vias (TSVs). To enable the fabrication of the TSVs and to improve the reliability of the TSVs, the WSII can be ground, polished, and so on to reduce the thickness of the WSII. The resulting thin WSII can be delicate and therefore susceptible to fracturing. Bonding of the MPSs can be based on reflowing, by a laser, one or more solder balls. The reflowing the solder balls solders or bonds the MPSs to the WSII.

Disclosed is a system for power delivery comprising: a wafer-scale integration interposer (WSII), wherein a front side of the WSII is bonded to a plurality of chiplets, wherein the WSII includes a plurality of through-silicon vias (TSVs); a plurality of modular power substrates (MPSs), wherein the plurality of MPSs is bonded to a back side of the WSII, wherein the bonding is accomplished via laser-assisted bonding (LAB); and a plurality of DC-to-DC power converters, wherein the plurality of DC-to-DC power converters is coupled electrically to the plurality of MPSs, wherein the system, when provided DC power, is configured to: send DC power, by the plurality of DC-to-DC power converters, to the plurality of chiplets, wherein the sending is based on the plurality of MPSs and the plurality of TSVs.

The system 1200 includes a wafer-scale integration interposer (WSII) 1210, wherein a front side of the WSII is bonded to a plurality of chiplets 1220, wherein the WSII includes a plurality of through-silicon vias (TSVs) 1212. The WSII can comprise an inorganic wafer such as a silicon wafer, a glass wafer, and so on. The WSII can include an organic wafer. The plurality of chiplets can include general purpose chiplets such as processor chiplets, multiprocessor chiplets, graphics processor chiplets, memory chiplets, switching chiplets, application-specific integrated circuits (ASICs), systems-on-chip (SoCs), memory chiplets, I/O chiplets, artificial intelligence (AI) and machine learning (ML) accelerators, and so on. The plurality of chiplets can include optical chips such as VCSELs, LEDs etc. The chiplets can be bonded to the WSII via micro-bumps, controlled collapse chip connections (C4s), and so on. The WSII includes a plurality of through-silicon vias (TSVs) 1212. A TSV can include an electrical connection that completely passes through a wafer such as a silicon wafer or a die. The plurality of TSVs is oriented vertically in order to enable connections between the front side of the wafer and the back side of the wafer.

The system 1200 includes a plurality of modular power substrates (MPSs) 1230, wherein the plurality of MPSs is bonded to a back side of the WSII, wherein the bonding is accomplished via laser-assisted bonding (LAB). Described previously and throughout, the MPSs can include one or more DC-to-DC converters, a high voltage socket, a high voltage connector, and so on. In embodiments, each MPS within the plurality of MPSs is based on a form factor mirroring one or more corresponding chiplets within the plurality of chiplets on the front side of the WSII. The system can include an isometric grid array (IGA) (not shown). The IGA can accomplish stiffening of the WSII. In embodiments, the IGA maintains a coplanarity of the WSII. Maintaining coplanarity of the WSII reduces the risk of the WSII fracturing or cracking under pressure applied by the IGA. The laser-assisted bonding can bond the MPSs to the back side of the WSII without disturbing other micro-bumps, C4s, BGA, etc. such as may be included in the bonding of the chiplets to the WSII.

The system 1200 includes a plurality of DC-to-DC power converters 1240, wherein the plurality of DC-to-DC power converters are coupled electrically to the plurality of MPSs. The DC-to-DC converters can convert DC power from a high DC voltage range, such as 48 volts to 54 volts, to a lower DC voltage range, such as 12 volts to 13.5 volts.

In embodiments, the plurality of DC-to-DC power converters comprises a unified circuit board (UCB), wherein the UCB is coupled electrically to the plurality of MPSs by a plurality of high-power sockets. The UCB is not shown in system 1200. The DC-to-DC converters can be mounted on the unified control board (UCB). The UCB can provide controls such as control signals, and power such as DC power, to the DC-to-DC converters. The UCB can comprise a single control board. The single control board can include an organic control board or an inorganic control board. The UCB can comprise multiple control boards and/or circuits. The UCB can include a printed circuit board (PCB). The PCB can include a ceramic board, a glass board, and the like. In some embodiments, the PCB comprises aluminum nitride. Aluminum nitride can have a similar CTE to silicon, reducing the lateral displacement between the WSII and the UCB during operation. The UCB can be coupled to the plurality of MPSs using connectors such as high-power connectors, rigid connectors, high voltage connectors, and the like. The connectors can be based on a high-power socket (which can be a high voltage socket). The connectors can be based on a compliant connector. The modularity of the MPSs can allow for movement between the UCB and the WSII. Movement, such as linear displacement, can occur due to differences in coefficients of thermal expansion (CTE). The UCB can include one or more control circuits. The system 1200, when provided power, is configured to: send DC power, by the plurality of DC-to-DC power converters, to the plurality of chiplets, wherein the sending is based on the plurality of MPSs and the plurality of TSVs. The sending can include the first voltage conversion, and the second voltage conversion as described above.

Each of the above methods may be executed on one or more processors on one or more computer systems. Embodiments may include various forms of distributed computing, client/server computing, and cloud-based computing. Further, it will be understood that the depicted steps or boxes contained in this disclosure's flow charts are solely illustrative and explanatory. The steps may be modified, omitted, repeated, or re-ordered without departing from the scope of this disclosure. Further, each step may contain one or more sub-steps. While the foregoing drawings and description set forth functional aspects of the disclosed systems, no particular implementation or arrangement of software and/or hardware should be inferred from these descriptions unless explicitly stated or otherwise clear from the context. All such arrangements of software and/or hardware are intended to fall within the scope of this disclosure.

The block diagram and flow diagram illustrations depict methods, apparatus, systems, and computer program products. The elements and combinations of elements in the block diagrams and flow diagrams show functions, steps, or groups of steps of the methods, apparatus, systems, computer program products and/or computer-implemented methods. Any and all such functions—generally referred to herein as a “circuit,” “module,” or “system” may be implemented by computer program instructions, by special-purpose hardware-based computer systems, by combinations of special purpose hardware and computer instructions, by combinations of general-purpose hardware and computer instructions, and so on.

A programmable apparatus which executes any of the above-mentioned computer program products or computer-implemented methods may include one or more microprocessors, microcontrollers, embedded microcontrollers, programmable digital signal processors, programmable devices, programmable gate arrays, programmable array logic, memory devices, application specific integrated circuits, or the like. Each may be suitably employed or configured to process computer program instructions, execute computer logic, store computer data, and so on.

It will be understood that a computer may include a computer program product from a computer-readable storage medium and that this medium may be internal or external, removable and replaceable, or fixed. In addition, a computer may include a Basic Input/Output System (BIOS), firmware, an operating system, a database, or the like that may include, interface with, or support the software and hardware described herein.

Embodiments of the present invention are limited to neither conventional computer applications nor the programmable apparatus that run them. To illustrate: the embodiments of the presently claimed invention could include an optical computer, quantum computer, analog computer, or the like. A computer program may be loaded onto a computer to produce a particular machine that may perform any and all of the depicted functions. This particular machine provides a means for carrying out any and all of the depicted functions.

Any combination of one or more computer readable media may be utilized including but not limited to: a non-transitory computer readable medium for storage; an electronic, magnetic, optical, electromagnetic, infrared, or semiconductor computer readable storage medium or any suitable combination of the foregoing; a portable computer diskette; a hard disk; a random access memory (RAM); a read-only memory (ROM); an erasable programmable read-only memory (EPROM, Flash, MRAM, FeRAM, or phase change memory); an optical fiber; a portable compact disc; an optical storage device; a magnetic storage device; or any suitable combination of the foregoing. In the context of this document, a computer readable storage medium may be any tangible medium that can contain or store a program for use by or in connection with an instruction execution system, apparatus, or device.

It will be appreciated that computer program instructions may include computer executable code. A variety of languages for expressing computer program instructions may include without limitation C, C++, Java, JavaScript™, ActionScript™, assembly language, Lisp, Perl, Tcl, Python, Ruby, hardware description languages, database programming languages, functional programming languages, imperative programming languages, and so on.

In embodiments, computer program instructions may be stored, compiled, or interpreted to run on a computer, a programmable data processing apparatus, a heterogeneous combination of processors or processor architectures, and so on. Without limitation, embodiments of the present invention may take the form of web-based computer software, which includes client/server software, software-as-a-service, peer-to-peer software, or the like.

In embodiments, a computer may enable execution of computer program instructions including multiple programs or threads. The multiple programs or threads may be processed approximately simultaneously to enhance utilization of the processor and to facilitate substantially simultaneous functions. By way of implementation, any and all methods, program codes, program instructions, and the like described herein may be implemented in one or more threads which may in turn spawn other threads, which may themselves have priorities associated with them. In some embodiments, a computer may process these threads based on priority or other order.

Unless explicitly stated or otherwise clear from the context, the verbs “execute” and “process” may be used interchangeably to indicate execute, process, interpret, compile, assemble, link, load, or a combination of the foregoing. Therefore, embodiments that execute or process computer program instructions, computer-executable code, or the like may act upon the instructions or code in any and all of the ways described. Further, the method steps shown are intended to include any suitable method of causing one or more parties or entities to perform the steps. The parties performing a step, or portion of a step, need not be located within a particular geographic location or country boundary. For instance, if an entity located within the United States causes a method step, or portion thereof, to be performed outside of the United States, then the method is considered to be performed in the United States by virtue of the causal entity.

While the invention has been disclosed in connection with preferred embodiments shown and described in detail, various modifications and improvements thereon will become apparent to those skilled in the art. Accordingly, the foregoing examples should not limit the spirit and scope of the present invention; rather it should be understood in the broadest sense allowable by law.

What is claimed is:

1. A method for power delivery comprising:
accessing a wafer-scale integration interposer (WSII), wherein a front side of the WSII is bonded to a plurality of chiplets, wherein the WSII includes a plurality of through-silicon vias (TSVs);
bonding, to a back side of the WSII, a plurality of modular power substrates (MPSs), wherein the bonding is accomplished via laser-assisted bonding (LAB);
coupling electrically the plurality of MPSs to a plurality of DC-to-DC power converters; and
sending DC power, by the plurality of DC-to-DC power converters, to the plurality of chiplets, wherein the sending is based on the plurality of MPSs and the plurality of TSVs.

2. The method of claim 1 wherein the LAB comprises reflowing, by a laser, one or more solder balls, wherein the bonding is based on the one or more solder balls that were reflowed.

3. The method of claim 2 wherein the reflowing comprises shining the laser through a front side of the WSII.

4. The method of claim 2 wherein the one or more solder balls comprise controlled collapse chip connections (C4s).

5. The method of claim 1 wherein the bonding includes coupling each MPS within the plurality of MPSs to one or more chiplets within the plurality of chiplets, wherein the coupling includes one or more TSVs within the plurality of TSVs.

6. The method of claim 5 further comprising inserting each MPS within the plurality of MPSs that was bonded into an isometric grid array (IGA), wherein the IGA includes a plurality of open recesses.

7. The method of claim 6 wherein the plurality of open recesses comprises a grid.

8. The method of claim 7 wherein the IGA contacts the back side of the WSII between each MPS in the plurality of MPSs that were bonded.

9. The method of claim 8 further comprising mounting the IGA to a cold plate, wherein the cold plate contacts the plurality of chiplets bonded to the front side of the WSII.

10. The method of claim 9 wherein the mounting is based on one or more spring-loaded fasteners.

11. The method of claim 9 wherein the mounting is based on one or more clamps.

12. The method of claim 11 further comprising compressing the WSII, wherein the compressing is based on the mounting, and wherein the compressing maintains a coplanarity of the WSII.

13. The method of claim 6 wherein each MPS within the plurality of MPSs is based on a form factor mirroring one or more corresponding chiplets within the plurality of chiplets.

14. The method of claim 13 wherein each open recess within the plurality of open recesses within the IGA matches a form factor of each MPS in the plurality of MPSs.

15. The method of claim 1 wherein the plurality of DC-to-DC power converters comprise a unified control board (UCB), wherein the coupling electrically is based on a plurality of high-power sockets.

16. The method of claim 15 wherein the sending includes delivering the DC power, by the UCB, to the plurality of MPSs, wherein the delivering includes a first voltage conversion.

17. The method of claim 16 further comprising transferring the DC power that was delivered, by the plurality of MPSs, to the plurality of chiplets, wherein the transferring includes a second voltage conversion.

18. The method of claim 1 wherein the WSII comprises a photonic wafer-scale interposer (PWSI), wherein the PWSI includes a plurality of waveguides, wherein a first chiplet within the plurality of chiplets is coupled with a second chiplet within the plurality of chiplets based on a first waveguide within the plurality of waveguides.

19. The method of claim 18 wherein the PWSI comprises an optical wafer-scale network switch, wherein one or more chiplets in the plurality of chiplets comprise one or more switching chiplets.

20. The method of claim 18 wherein the PWSI comprises an optical wafer-scale AI accelerator, wherein one or more chiplets in the plurality of chiplets comprise one or more artificial intelligence (AI) accelerators.

21. An apparatus for power delivery comprising:
a wafer-scale integration interposer (WSII), wherein a front side of the WSII is bonded to a plurality of chiplets, wherein the WSII includes a plurality of through-silicon vias (TSVs);
a plurality of modular power substrates (MPSs), wherein the plurality of MPSs is bonded to a back side of the WSII, wherein the bonding is accomplished via laser-assisted bonding (LAB); and
a plurality of DC-to-DC power converters, wherein the plurality of DC-to-DC power converters is coupled electrically to the plurality of MPSs, and wherein the plurality of DC-to-DC power converters sends power to the plurality of chiplets bonded to the WSII based on the plurality of MPSs and the plurality of TSVs.

22. The apparatus of claim 21 wherein the plurality of DC-to-DC power converters comprises a unified circuit board (UCB), wherein the UCB is coupled electrically to the plurality of MPSs by a plurality of high-power sockets.

23. The apparatus of claim 21 further comprising an isometric grid array (IGA), wherein the IGA comprises a grid, wherein each MPS within the plurality of MPSs that was bonded is inserted into the IGA, and wherein the IGA maintains a coplanarity of the WSII.

24. The apparatus of claim 21 wherein the WSII comprises a photonic wafer-scale interposer (PWSI), wherein the PWSI includes a plurality of waveguides within the PWSI.

25. The apparatus of claim 24 wherein the PWSI comprises an optical wafer-scale network switch, wherein one or more chiplets in the plurality of chiplets comprise one or more switching chiplets, respectively.

26. The apparatus of claim 24 wherein the PWSI comprises an optical wafer-scale AI accelerator, wherein one or more chiplets in the plurality of chiplets comprises one or more artificial intelligence (AI) accelerators.

27. A system for power delivery comprising:
a wafer-scale integration interposer (WSII), wherein a front side of the WSII is bonded to a plurality of chiplets, wherein the WSII includes a plurality of through-silicon vias (TSVs);
a plurality of modular power substrates (MPSs), wherein the plurality of MPSs is bonded to a back side of the WSII, wherein the bonding is accomplished via laser-assisted bonding (LAB); and
a plurality of DC-to-DC power converters, wherein the plurality of DC-to-DC power converters is coupled electrically to the plurality of MPSs, wherein the system, when provided DC power, is configured to:
send DC power, by the plurality of DC-to-DC power converters, to the plurality of chiplets, wherein the sending is based on the plurality of MPSs and the plurality of TSVs.
